(19) United States
(12) Patent Application Publication
(10) Pub. No.: US 2005/0246216 A1
(43) Pub. Date: Nov. 3, 2005

(54) Systems and methods for managing information at various levels

(76) Inventors: Earl Rosen III, Richmond, VT (US); Cathy Conner Strobel, St. Louis, MO (US); Kenneth William Reece, Sunset Hills, MO (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 11/104,679

(22) Filed: Apr. 13, 2005

Related U.S. Application Data
(60) Provisional application No. 60/562,093, filed on Apr. 14, 2004.

(51) Int. Cl. G06F 17/60; G06K 7/10

(52) U.S. Cl. 705/8; 235/462.01

(57) ABSTRACT

A method for managing information at various levels is provided. The method includes obtaining information regarding a sample by scanning a barcode of the sample, generating, via a computer, at least one of a schedule of a task to be performed and a contact designated to perform the task, where generating is based on the information regarding the sample.

### CROSS REFERENCE TO RELATED APPLICATIONS

This application claims priority to U.S. Provisional Patent Application with Ser. No. 60/562,093, filed on Apr. 14, 2004, and hereby incorporated by referenced in its entirety.

### BACKGROUND OF THE INVENTION

This invention relates generally to information management and more particularly to systems and methods for managing information at various levels.

There is a wide variety of information available on the world wide web. People working on a specific project can access the wide variety of information. However, it is a difficult task to organize and therefore manage the information that is available on the web.

### BRIEF DESCRIPTION OF THE INVENTION

In one aspect, a method for managing information at various levels is provided. The method includes obtaining information regarding a sample by scanning a barcode of the sample, generating, via a computer, at least one of a schedule of a task to be performed and a contact designated to perform the task, where generating is based on the information regarding the sample.

In another aspect, a method for managing information at various levels is provided. The method includes receiving, by a computer, a due date and a task to be completed by the due date, determining, by the computer, whether a contact has completed the task by the due date, and sending, by the computer, an electronic mail notification upon determining that the contact has not completed the task by the due date.

In yet another embodiment, a method for managing information at various levels is provided. The method includes exporting, by a computer, original information to a formatted template, processing the original information to generate processed information, and determining, by the computer, whether to replace the original information in the computer with the processed information.

### BRIEF DESCRIPTION OF THE DRAWINGS

FIG. 1 is a block diagram of an embodiment of a system for managing information at various levels.

FIG. 2 is a detailed diagram of another embodiment of a system for managing information at various levels.

FIG. 3 is a flowchart of an embodiment of a method for managing information at various levels.

FIG. 4 shows an exemplary regular list view of first level item listings that is displayed when a user logs into the system of FIG. 1.

FIG. 5 shows an exemplary first level item schedule view in which first level items can be displayed.

FIG. 6 shows an exemplary first level item attribute screen showing first level item attributes of a first level item.

FIG. 7 shows another exemplary regular list view of first level item listings.

FIG. 8 shows another exemplary first level item attribute screen including first level item attributes of a first level item.

FIG. 9 shows an exemplary regular list view of second level item listings associated with a first level item.

FIG. 10 shows an exemplary second level item attribute screen including second level item attributes of a second level item.

FIG. 11 shows another exemplary second level item attribute screen including second level item attributes of a second level item.

FIG. 12 shows yet another exemplary second level item attribute screen including second level item attributes of a second level item.

FIG. 13 is an exemplary multiple list view including second level items.

FIG. 14 shows an exemplary regular list view including third level items associated with a first level item.

FIG. 15 shows an exemplary third sub-level item attribute screen including third sub-level item attributes of a third sub-level item associated with a third level item.

FIG. 16 shows an exemplary contact sheet view including third level items.

FIG. 17 shows an exemplary third level item attribute screen including third level item attributes.

FIG. 18 shows an exemplary fourth level item listings view including fourth level item listings associated with a first level item.

FIG. 19 shows an exemplary fourth level item attribute screen including fourth level item attributes of a fourth level item associated with a first level item.

FIG. 20 shows an exemplary administration screen that is generated when a user selects a button on the first level item schedule view of FIG. 5.

FIG. 21 shows a default workflow screen displayed when a user selects a button on the administration screen of FIG. 20.

FIG. 22 is a flowchart of another embodiment of a method for managing information at various levels.

FIG. 23 shows another embodiment of an administration screen.

FIG. 24 shows an exemplary directory screen generated when a user selects a button on the administration screen of FIG. 23.

FIG. 25 an exemplary edit first level item attribute definitions screen generated when a user selects a button on the directory screen of FIG. 24.

FIG. 26 shows an exemplary portion of an add attribute screen generated when a user selects a button on the edit first level item attribute definitions screen of FIG. 25.

FIG. 27 shows another exemplary portion of the add attribute screen of FIG. 26.

FIG. 28 shows yet another exemplary portion of the add attribute screen of FIG. 26.

FIG. 29 shows an exemplary personnel timeline report when a user selects a button on the first level item schedule view of FIG. 5.

FIG. 30 shows another exemplary personnel timeline report.

FIG. 31 shows an exemplary timeline detail report when a user selects a button on the personnel timeline report of FIG. 30.

FIG. 32 shows an exemplary third level items past due report generated when a user selects a button on the personnel timeline report of FIG. 29.

FIG. 33 shows an exemplary fourth level item past due report generated when a user selects a button on the third level items past due report of FIG. 32.

FIG. 34 shows an exemplary search screen generated when a user selects a button on the first level item schedule view of FIG. 5.

FIG. 35 is a flowchart of another embodiment of a method for managing information at various levels.

FIG. 36 is a flowchart of yet another embodiment of a method for managing information at various levels.

FIG. 37 shows an exemplary regular list view of first level item listings accessed by a user by selecting desired filters.

FIG. 38 shows an exemplary shortcuts view generated when a user selects an icon on the regular list view of FIG. 37.

FIG. 39 shows an exemplary add global shortcut screen generated when a user selects a button on the shortcuts view of FIG. 38.

FIG. 40 shows an exemplary shortcuts screen generated when a user selects a button on the add global shortcut screen of FIG. 39.

FIG. 41 shows an exemplary edit shortcut view generated when a user selects a button on the shortcuts view of FIG. 38

FIG. 42 shows an exemplary shortcuts view generated when a user selects a button on the edit shortcut view of FIG. 41.

FIG. 43 shows an exemplary web page generated when a user selects a button on the shortcuts view of FIG. 42.

FIG. 44 is a flowchart of an embodiment of a method for managing information at various levels.

FIG. 45 is a flowchart of another embodiment of a method for managing information at various levels.

FIG. 46 shows an exemplary third level item screen generated when a user selects a button on the regular list view of FIG. 14.

FIG. 47 shows an exemplary assign fourth level items screen generated when a user selects a button on the regular list view of FIG. 14.

FIG. 48 shows an exemplary assign fourth level items screen generated when a user selects a button on the assign fourth level items screen of FIG. 47.

### DETAILED DESCRIPTION OF THE INVENTION

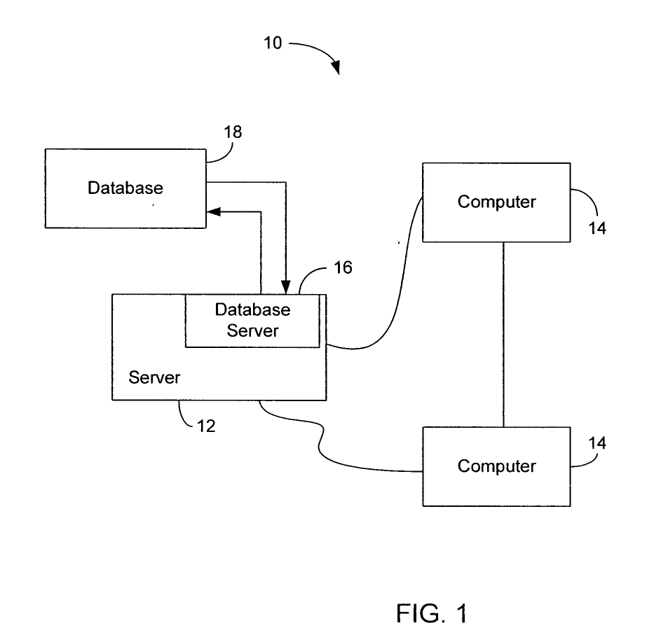

FIG. 1 is a block diagram of an embodiment of a system 10 for managing information at various levels. System 10 includes a server sub-system 12, sometimes referred to herein as server 12, and a plurality of user devices 14 connected to server 12. As used herein, the term server is not limited to just those integrated circuits referred to in the art as a computer, but broadly refers to a processor, a microcontroller, a microcomputer, a programmable logic controller, an application specific integrated circuit, any other programmable circuit, and any combination of hardware and software, and these terms are used interchangeably herein. In one embodiment, devices 14 are computers including a web browser, and server 12 is accessible to devices 14 via a network, such as, a local area network (LAN) and a wide area network (WAN). The LAN may include an Intranet and the WAN may include the Internet. In an alternative embodiment, devices 14 are servers for a network of customer devices.

Devices 14 are interconnected to the network through many interfaces including dial-in-connections, cable modems and high-speed integrated services digital network (ISDN) lines. Alternatively, devices 14 include a web-based phone or other web-based connectable equipment, which are capable of interconnecting to the network. Server 12 includes a database server 16 connected to a centralized database 18 that includes first level item information regarding a first level item, second level item information regarding a second level item, third level item information regarding a third level item, or fourth level item information regarding a fourth level item. Information at a level, such as a first level, a second level, a third level, or a fourth level, is information regarding an item at the level. For example, first level item information is information regarding a first level item. Examples of a level include a first level, a second level, a third level, and a fourth level. A first level item may include a second level item or a third level item, a second level item may include a third level item, and a third level item may include a fourth level item.

An example of a first level item includes a project developed to obtain and refine a second, a third, or a fourth level item. An example of a second level item includes a page describing a product or a service. Another example of a second level item includes a document describing a product or a service. An example of a third level item is a shot that includes multiple images displaying a product or a service, and an example of a fourth level item is a sample of a product or a service. A shot includes at least one image. In one embodiment, a shot is a refined version of a sample. For example, a shot is an image placed in a catalog after modifying the image to make the image presentable to a certain group of people. An example of a sample includes a physical item such as a physical inventory item or a prototype of the inventory item. Examples of a physical item include a shoe, a toaster, a cloth, a software, and a piece of hardware. Examples of hardware includes a computer, a cellular phone, a personal digital assistant, and a scanner.

Information regarding a physical item is provided to system 10 in various ways, such as, by providing a photograph taken by a user of the physical item in a user's home or by scanning a barcode located on the physical item. A barcode includes information such as a description, a location, a vendor, and facts related to a product. A barcode is used to enter information regarding a product from which portions of first level item information, second level item information, third level item information, or fourth level item information are created. In one embodiment, a sample is an unrefined version of a shot. In another embodiment, a sample is information obtained regarding physical inventory in various ways, such as scanning a barcode on the physical inventory or by taking a picture the physical inventory.

Another example of a second level item includes a work element and a third level item includes a task. An example of a project includes a milestone of installing a human resources software. An example of a first work element includes determining people resources necessary, a second work element includes determining people available to perform the project, and a third work element includes confirming a reassignment of people to the project. Examples of tasks under the first work element include reviewing past projects similar to a project of installing a human resources software, interviewing software vendors for recommendations of the human resources software, reviewing budget for funding the project, and creating a realistic people resource requirements document. Other examples of tasks include whether an image has been approved, an image is rejected, an image creation is in progress, the image creation is complete, and an approval is pending. When tasks included within the first work element are complete, the first work element is complete. When the first, second and third work elements are complete, the milestone is accomplished.

In one embodiment, centralized database 18 is stored on database server 16 and can be accessed by potential users at one of user devices 14 by logging onto server 12 through one of user devices 14. In an alternative embodiment centralized database 18 is stored remotely from server 12.

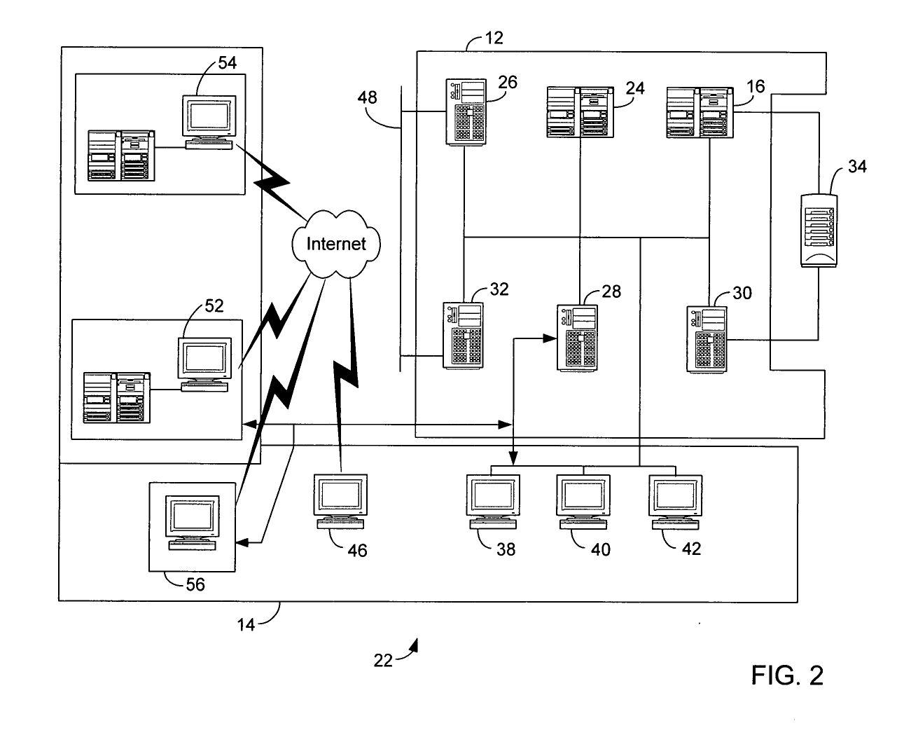

FIG. 2 is a detailed block diagram of an embodiment of a system 22 for managing information at various levels. System 22 includes server 12 and user devices 14. Server 12 includes database server 16, an application server 24, a web server 26, a fax server 28, a directory server 30, and a mail server 32. A disk storage unit 34, which is a single database, is coupled to database server 16 and directory server 30. Examples of different types of legacy systems linked together via system 22 include a Gerber WEB PDM™ database, a JDA™ database, a Retek™ database, a Market Max™ database, an Oracle™ database, a Sybase™ database, a DB2™ database, and a Microsoft™ Access database. In one embodiment, server 12 receives a level item, such as a second or a third level item, from the legacy systems and stores the level item in disk storage unit 34. In an alternative embodiment, server 12 receives level item information, such as a first, second, third, or fourth level item information, from the legacy systems and stores the level item information in disk storage unit 34. In yet another alternative embodiment, a user controls server 12 to create and store a level item, such as a second or a third level item, in disk storage unit 34. In still another alternative embodiment, a user controls server 12 to create and store level item information in disk storage unit 34.

In one embodiment, server 12 receives some level item information from the legacy systems and other level item information created by server 12, and creates levels, such as first, second, third, and fourth levels. For example, server receives second level item information from the legacy systems and receives first level item information created by server 12, and creates levels.

Servers 16, 24, 26, 28, 30, and 32 are coupled in a local area network (LAN) 36. Alternatively, a WAN could be used in place of LAN 36. In addition, a system administrator work station 38, a user work station 40, and a supervisor work station 42 are coupled to LAN 36. Alternatively, work stations 38, 40, and 42 are coupled to LAN 36 via an Internet link or are connected through an intranet.

Each work station 38, 40, and 42 is a personal computer having a web browser. Although functions performed at the work stations 38, 40, and 42 typically are illustrated as being performed at respective work stations 38, 40, and 42, such functions can be performed at one of many personal computers coupled to LAN 36. Work stations 38, 40, and 42 are illustrated as being associated with separate functions to facilitate an understanding of the different types of functions that can be performed by individuals having access to LAN 36.

Server 12 is communicatively coupled to various workstations 52 and 54, which are operated by individuals or employees. Any employee or user operating work station 52 can access server 12. Work stations 52 and 54 are personal computers having a web browser. Work station 54 is located at a remote location. Server 12 is also communicatively coupled to a workstation 46 via an internet service provider (ISP) connection 48. The communication in the exemplary embodiment is illustrated as being performed via the Internet, however, any other wide area network (WAN) type communication can be utilized in other embodiments, i.e., systems and methods for managing information at various levels are not limited to being practiced via the Internet.

Furthermore, fax server 28 communicates with workstation 52 and any remotely located user system, including a workstation 56 via a telephone link. Fax server 28 communicates with other work stations 38, 40, and 42 as well. Methods for managing information at various levels are stored in disk storage unit 34, which is an example of a computer-readable medium, and are executed by any of servers 16, 24, 26, 28, 30, and 32. Other examples of a computer readable medium include a floppy disk, a compact disc-read only memory (CD-ROM), and a digital video disk (DVD).

Server 12 provides an ability to integrate physical assets, such as samples, into a project management environment. In addition, server 12 combines information which resides in data systems, such as the legacy systems or local excel documents, with automated project management tools in levels, such as the first, second, third, and fourth levels, and provides an ability to utilize barcode asset recognition technology.

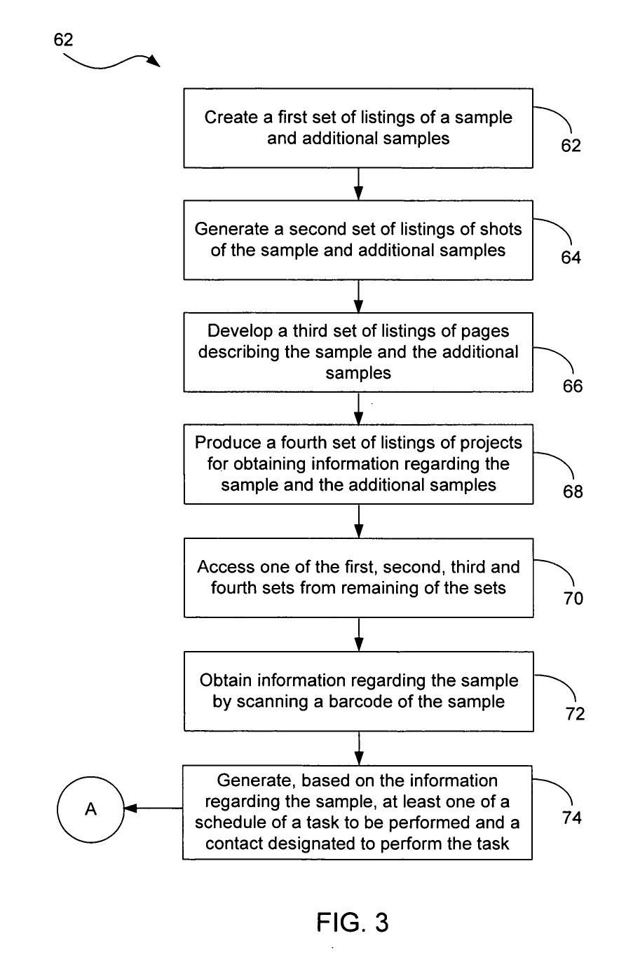

FIG. 3 is a flowchart of an embodiment of a method 60 for managing information at various levels. Method 60 includes creating 62 a first set of listings of a sample and additional samples, generating 64 a second set of listings of shots of the sample and the additional samples, developing 66 a third set of listings of pages describing the sample and the additional samples, and producing 68 a fourth set of listings of projects for obtaining information regarding the sample and the additional samples. Method includes accessing 70 one of the first, second, third, and fourth sets of listings from remaining of the first, second, third, and fourth sets of listings. Method 60 includes obtaining 72 information regarding a sample by scanning a barcode of the sample. For example, information regarding a physical item is provided to system 10 by scanning a barcode located on the physical item. Barcodes may be entered into disk storage unit 34 either by typing or scanning with a barcode scanner. Information regarding a product or a service can be entered into disk storage unit 34 in other ways, such as, by typing information regarding the product or the service into a personal digital assistant, any of computers 38, 40, 42, 46, 52, 54, and 56, or cell phones operationally coupled to application server 24. Method 60 also includes generating 74, based on the information regarding a sample, at least one of a schedule of a task to be performed and a contact designated to perform the task.

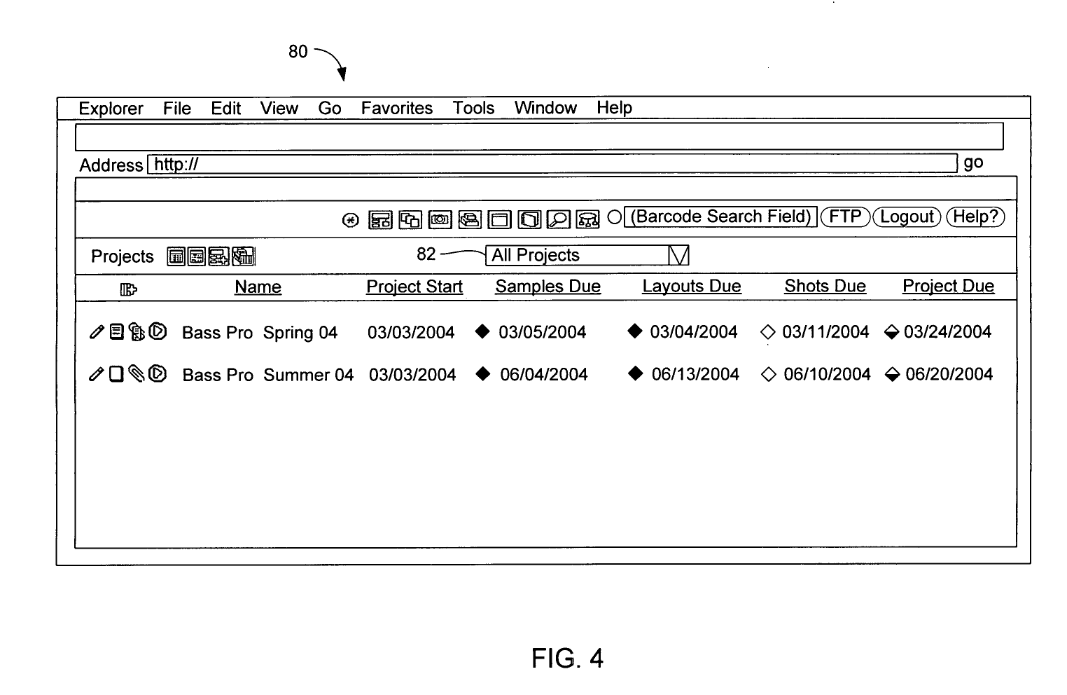

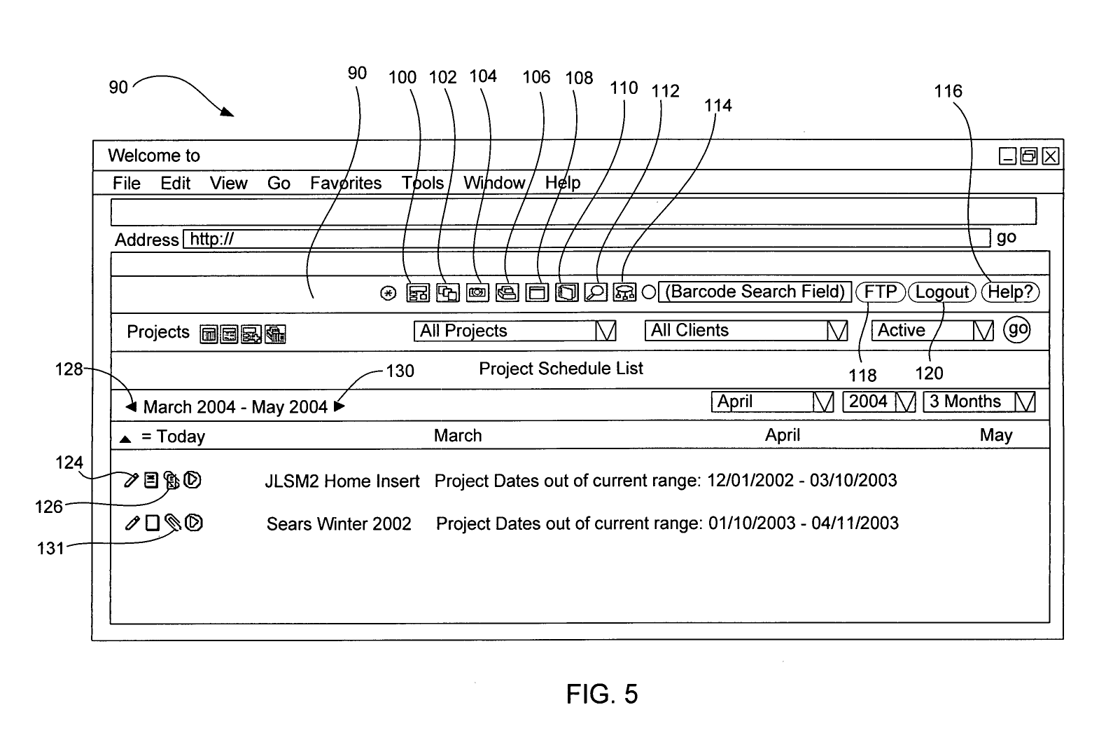

FIG. 4 is an exemplary regular list view 80 of first level item listings that is displayed by server 12 when a user logs into server 12. Regular list view 80 includes first level item listings, such as “Bass Pro Spring 04” and “Bass Pro Summer 04”, of first level items. In one embodiment, server 12, filters first level item listings in regular list view 80 by statuses of first level items and sorts the first level item listings by names of the first level items. When a first level item is selected by a user from a first level item drop down selection field 82, the user enters a context of that first level item. For example. when a first level item is selected by a user from first level item drop down selection field 82, server 12 switches regular list view 80 to a second level item listing for the first level item. Alternatively, server 12 displays first level items in a first level item schedule view 90, shown in FIG. 5.

First level item schedule view 90 includes a top bar 98. Top bar 98 includes a first level item listings button 100, a second level item listings button 102, a third level item listings button 104, a fourth level item listings button 106, a reports menu button 108, an address book button 110, a search button 112, an administration menus button 114, a help button 116, an indicator 118, a file transfer protocol (FTP) button 120, and a logout button 122. Each first level item listing in first level item schedule view 90 is preceded by a set of buttons including an edit button 124 and an attachments button 126. First level item schedule view 90 also includes a previous arrow 128 and a next arrow 130.

First level item schedule view 90 includes first level item information in a timeline view with a completion status indicated by at least two colors filling a horizontal bar for each first level item. When a user specifies a starting date, such as “April 2004”, and a time period, such as “March 2004-May 2004”, server 12 displays first level item listings within the time period on first level item schedule view 90. Previous and next arrows 128 and 130 are present on either side of a date shown within first level schedule view 90. When a user selects previous arrow 128, server 12 generates an update including first level item listings for a time period that precedes a time period increment, “March 2004 May 2004”, shown in first level item schedule view 90. When a user selects next arrow 130, server 12 creates an update including first level item listings for a time period that is next to and following the time period shown in first level item schedule view 90.

In one embodiment, a first level item schedule bar generated by server 12 may be included within first level item schedule view 90. The first level item schedule bar includes a time of beginning a first level item and a schedule for completion of the first level item. A colored area of the first level item schedule bar notifies a user whether a first level item is on schedule by showing a number of level items, such as second, third, or fourth level items that have been completed compared to a number of level items that are scheduled to be completed by a date. For example, when server 12 determines that 100 third level items are scheduled to be completed by a date and 90 have actually been completed, server 12 displays the colored area of the first level item schedule bar to be 10% behind a date marker to indicate that a first level item is behind schedule. As another example, when server 12 determines that all 100 third level items are complete, server 12 displays the colored area of the first level item schedule bar as even with the date marker indicating that a first level item is on schedule. When server 12 determines that more third level items are completed than scheduled, server 12 displays the colored area of the first level item schedule bar as exceeding the date marker to indicate that a first level item is ahead of schedule.

When server 12 generates indicator 118 in an active navigation mode, a user may search for barcodes stored within disk storage unit 34. A user may enter new barcodes into system 22 when indicator 118 is in an inactive data entry mode. Server 12 toggles between the active navigation mode and the inactive data entry mode when a user selects indicator 118. Server 12 generates FTP button 120, which is a link to an upload location. For example, server 12 uploads files in a bulk when a user selects FTP button 120. An example of a link includes a hyperlink. When a user selects logout button 122, server 12 terminates a user session executing method 60 for managing information at various levels.

When a user selects attachments button 126, an attachments editor is accessed from server 12. The attachments editor displays attachments associated, such as hyperlinked, with a first level item listing in first level item schedule view 90 and allows a user to add attachments or delete existing attachments. In one embodiment, server 12 displays attachments button 126 in one of two states including a grayed-out state, which signifies that currently no attachments are associated with a first level item listing and a normal state, which signifies that there are one or more currently associated attachments with the first level item listing. An example of attachments button 126 in a grayed-out state is an add attachments button 131. In an alternative embodiment, server 12 displays attachments button 126 in one of three states including a filled-in state, an empty state, and a grayed-out state. A filled-in state of attachments button 126 signifies that there are one or more attachments currently associated by server 12 with a first level item listing. When a user selects attachments button 126 in a filled-in state, an edit attachment editor for viewing, responding, or editing attachments associated with a first level item listing is accessed from server 12. An empty state of attachments button 126 signifies that there are currently no attachments associated with a first level item listing. When a user selects attachments button 126 in an empty state, an add attachments editor is accessed from server 12. A grayed-out state of attachments button 126 signifies that a user does not have permission to view or add attachments currently associated with a first level item listing.

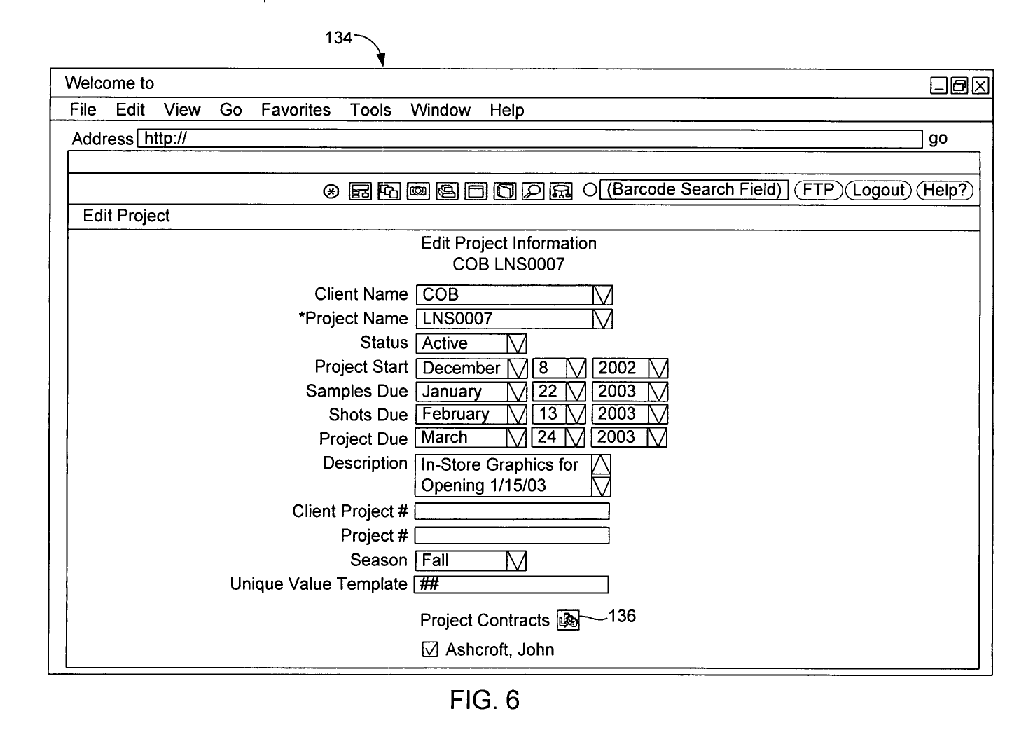

When a user selects edit button 124, an attribute editor is accessed from server 12. The attribute editor displays, as shown in an edit attribute screen 134 of FIG. 6, project attributes including a client or a merchant name, a project name, a status of a project, a project start date, a samples due date, a shots due date, a project due date, a description of the project, a client project number, a host project number, a season in which the project is to be performed, a unique value template number for the project, and project contacts, which are people assigned to work on the project. An example of a samples due date is a due date for obtaining a sample. An example of a shots due date is a due date for obtaining a shot of a sample. An example of a project due date is a due date for completing a project that may include obtaining level item information. A user controls server 12 to edit project attributes.

A user edits any fields included within edit attribute screen 134 to change first level item attributes. When a user selects an icon 136, a user controls server 12 to generate a contact designated to perform a task. For example, when a user selects icon 136, a choose contacts editor is accessed from server 12 to add contacts to a first level item. A choose contacts editor includes lists of contacts and allows a user to add or remove contacts from a given task associated with a level item, such as a first level, a second level, a third level, or a fourth level item.

Server 12 receives a user's selection of an update first level item button included within edit attribute screen 134 and saves changes to first level item attributes. Alternatively, when server 12 receives a user's selection of a return button, server 12 does not update first level item attributes and provides access to a first level item listing. When first level item attributes are successfully updated by server 12, a second level item listing corresponding to a first level item is displayed by server 12 or alternatively a third level item listing is displayed by server 12 when there are no second level items corresponding to the first level item.

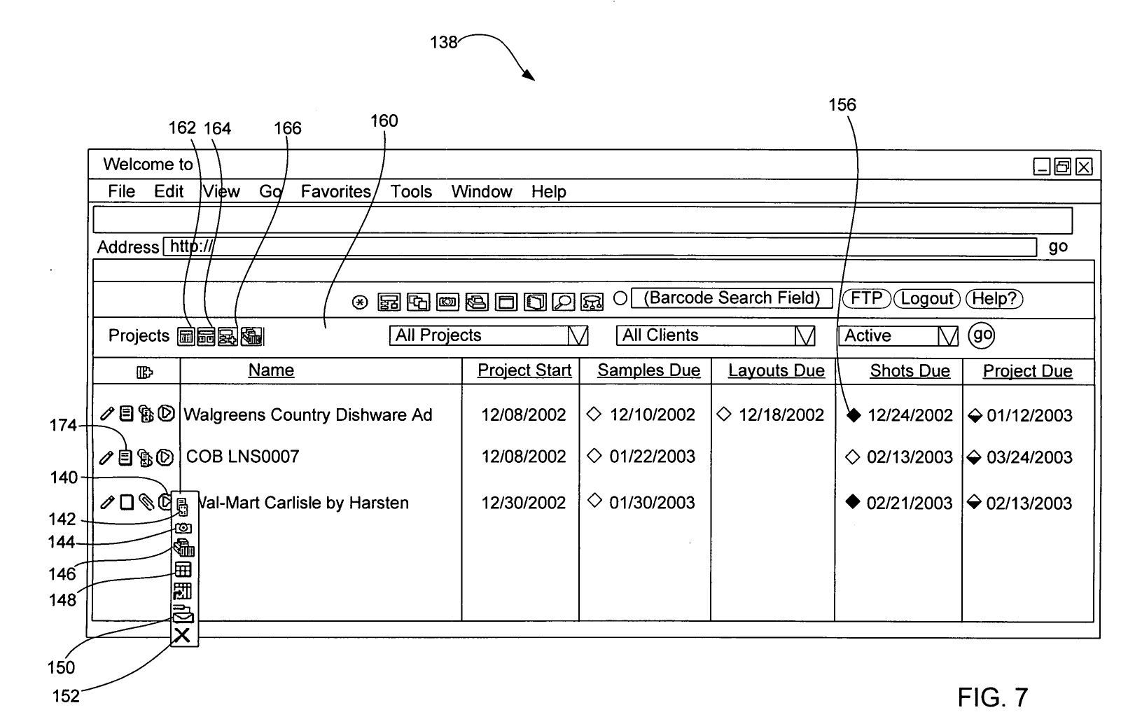

FIG. 7 shows another exemplary regular list view 138 of first level item listings that is displayed by server 12 when a user logs into server 12. Regular list view 138 includes a popup menu button 140. When a user selects popup menu button 140, server 12 generates a popup menu that includes a view second level items for this first level item button 142, a view third level items for this first level item button 144, a view fourth level items for this first level item button 146, a first level item workflow builder button 148, a first level item (electronic mail) email scheduler button 150, and a delete this first level item button 152. Regular list view 138 also includes an icon 156 and a first level item list bar 160. A set of buttons that appear on first level item list bar 160 includes a display first level items in a regular list button 162, a display first level items in a schedule view button 164, and an add first level items editor button 166. Regular list view 138 further includes a notes editor button 174.

When a user selects view second level items for this first level item button 142, a second level item listing with second level item information specific to a first level item is generated by server 12. When a user selects view third level items for this first level item button 144, a third level item listing with third level item information specific to a first level item is developed by server 12. When a user selects view fourth level items for this first level item button 146, a fourth level item listing with fourth level item information specific to a first level item is produced by server 12.

A user selects first level item workflow builder button 148. When a user selects first level item workflow builder button 148, server 12 generates 74 (FIG. 3) at least one of a schedule of a task to be performed and a contact designated to perform the task based on first level item information related to fourth level item information. For example, a user selects first level item workflow builder button 148 and a workflow builder displays, in an editable form, scheduled tasks and contacts assigned, such as includes a project for obtaining an image of a sample. A user controls server 12 to assign contacts to a task at any of first, second, third, or fourth levels.

When a user selects first level item email scheduler button 150, server 12 provides access to an email scheduler. An email scheduler allows a user to specify an event that triggers an email to be sent to a designated user. Examples of an event that can trigger an email are a level item, such as a third level item or a fourth level item, and specific tasks past due.

Server 12 receives a user's selection of delete this first level item button 152, and removes a first level item and a first level item listing from first level item listings included within regular list view 138. A user having permission controls server 12 to delete a first level item.

Regular list view 138 includes due date information for a level item, such as a due date of a third level item, and icon 156 indicates a completion status of the level item corresponding to a first level item. In one embodiment, icon 156 indicates one of two states including complete indicated by a solid blue icon and incomplete indicated by a solid white icon. In an alternative embodiment, a completion status includes one of five states with each state indicating a range of completion. For example, no progress is indicated by a solid white icon. A completion between 1% and 34% is indicated by an icon that is 25% or approximately 25% filled with a color. A completion between 34% and 67% is indicated by an icon that is 50% or approximately 50% filled with a color. A completion between 67% and 99% is indicated by an icon that is 75% or approximately 75% filled with a color. A 100% completion is indicated by a solid blue icon. When a user places a cursor on top of icon 156, server 12 displays a message that provides details of completion status, such as two third level items completed out of three third level items corresponding to a first level item.

When a user selects notes editor button 174, server 12 provides access to a notes editor. When a notes editor is accessed, a user controls server 12 to add notes and edit or delete existing notes associated with a first level item listing. In one embodiment, notes editor button 174 has one of 3 states including a filled-in note state, an empty note state, and a grayed-out note state. A filled-in note state of notes editor button 174 signifies that there are one or more notes currently associated with a first level item listing. When a user selects notes editor button 174 in a filled-in note state, an edit note editor is accessed from server 12. An empty note state of notes editor button 174 signifies that there are currently no notes associated with a first level item listing. When a user selects notes editor button 174 in an empty note state open, an add notes editor is accessed from server 12. A grayed-out note state of notes editor button 174 signifies that a user does not have permission to view or add notes currently associated with a first level item listing.

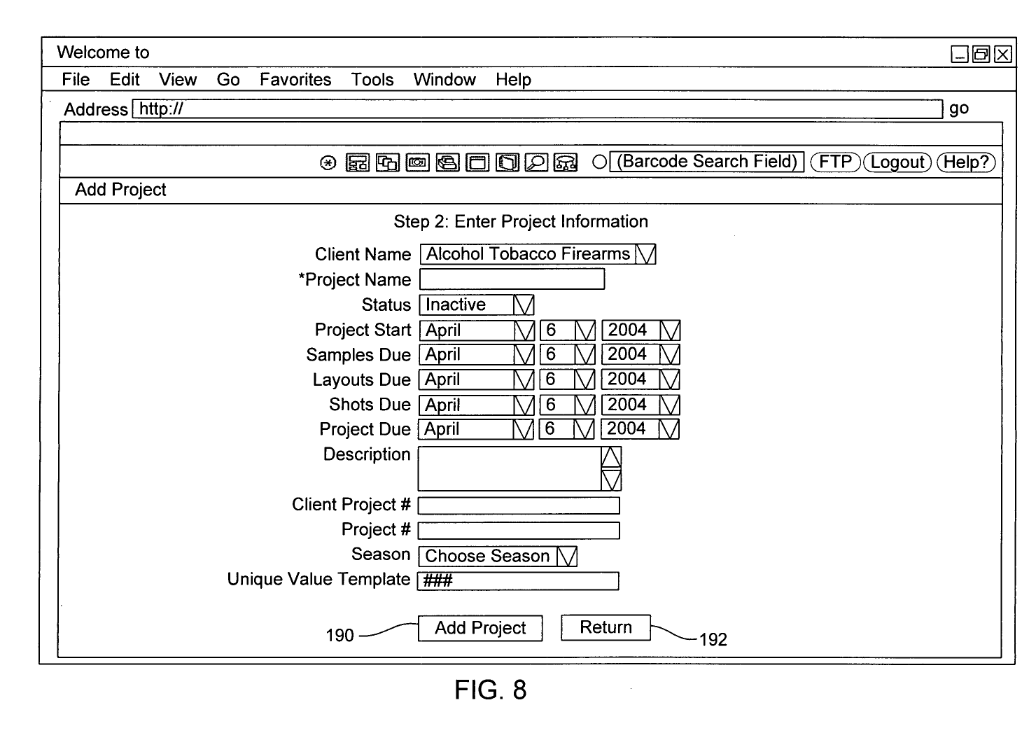

When a user selects add first level items editor button 166, server 12 initially prompts the user to select a client from a client list or add a new client which to the clients list. When a user chooses a client, an add first level item editor is accessed from server 12. An add first level item editor generates fields including first level item attributes, described above with reference to FIG. 6 and shown in FIG. 8.

A user can control server 12 to edit a first level item's attributes as desired, leaving fields blank or with default values. A first level item's attributes can at a later time be edited after a first level item listing has been created by server 12. Server 12 receives a user's selection of an add first level item button 190 and adds a first level item listing. When a user selects add first level item button 190, server 12 produces 68 (FIG. 3) a set of listings of projects. Alternatively, server 12 receives a user's section of a return button 192 and provides the user access to a first level item listing without adding a first level item listing. When server 12 adds a first level item listing, server 12 prompts a user to choose first level item contacts to be associated with the first level item listing. Server 12 receives a user's selection of icon 136 (FIG. 6) and provides access to a choose contacts editor to add contacts to a first level item listing.

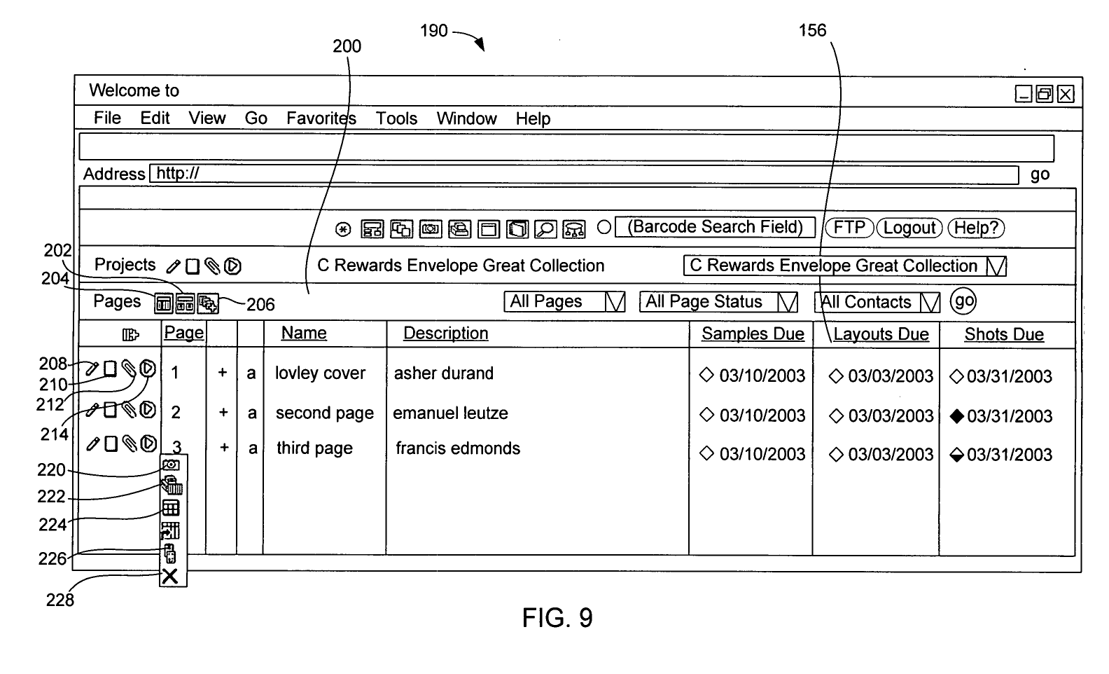

FIG. 9 shows an exemplary second level item list view 190, which is a regular list view. Second level item list view 190 includes second level item listings, such as “lovley cover” and “second page”, corresponding to a specified first level item, such as “C Rewards Envelope Great Collection”. Optionally, second level item listings for all first level items can be displayed by server 12. From second level item list view 190, a user can control server 12 to add, edit, and delete second level items.

Server 12 filters second level item listings in second level item list view 190 based on contacts. A cascading menu listing shows a first level item that second level item listings belong to. Server 12 provides access to a second level item listing from a first level item listing. For example, pages are listed under a project named “C Rewards Envelope Great Collection”.

Second level item list view 190 includes a second level item list bar 200. When a user specifies a first level item, server 12 displays a display second level items in a regular list button 202, a display second level items in a multiple list button 204, and an add second level item editor button 206 on second level item list bar 200. When a user selects all first level items, server 12 generates grayed-out icons on second level item list bar 200 and a user cannot add second level items unless a first level item is specified by the user. Server 12 receives a user's selection of display second level items in a regular list button 202 and displays second level item listings shown in second level item list view 190, with one second level item listing displayed per horizontal line.

At the left side of each second level item listing is an edit button 208, a notes editor button 210, an attachments button 212, and a popup menu button 214. When a user selects edit button 208, an editor is accessed from server 12 and the editor displays all information specific to a second level item listing on the same line as edit button 208.

When a user selects notes editor button 210, an editor that allows the user to add notes and edit or delete existing notes associated with a second level item listing is accessed from server 12. Notes editor button 210 has one of three states which are similar to the states described above with respect to notes editor button 174 (FIG. 7) except that the three states apply to second level items instead of first level items. For example, a filled-in note state of notes editor button 210 signifies that there are one or more notes currently associated with a second level item listing. When a user selects notes editor button 210 in a filled-in note state, an edit note editor is accessed from server 12.

When a user selects attachments button 210, an editor that allows the user to add attachments or delete existing ones associated with a second level item listing is accessed from server 12. In one embodiment, attachments button 210 has one of two states which are similar to the two states described above with respect to attachments button 126 (FIG. 5) except that the two states apply to second level items instead of first level items. For example, an empty state associated with attachments button 210 signifies that currently no attachments are associated with a second level item listing. In another embodiment, attachments button 210 has one of three states which are similar to the three states described above with respect to attachments button 126 (FIG. 5) except that the three states apply to second level items instead of first level items. For example, a grayed-out state associated with attachments button 210 signifies that a user does not have permission to view or add attachments currently associated with a second level item listing.

When a user selects a popup menu 214 button, server 12 displays a view third level items for this second level item button 220, a view fourth level items for this second level item button 222, a second level item workflow builder button 224, a copy/move this second level item button 226, and a delete this second level item button 228. When a user selects view third level items for this second level item button 220, server 12 provides access to a third level item listing with third level item information specific to a second level item. When a user selects view fourth level items for this second level item 222, a fourth level item listing with fourth level item information specific to a second level item is accessed from server 12. When a user selects second level item workflow builder button 224, a workflow builder is accessed from server 12, and the workflow builder allows the user to edit scheduled tasks and contacts specific to a second level item. When a copy/move this second level item button 226 is selected by a user, server 12 provides access to a copy/move editor. When a user selects delete this second level item button 228, server 12 deletes a second level item from a set of second level item listings. A deletion of a second level item is performed when a command is received by server 12 from a user having permission.

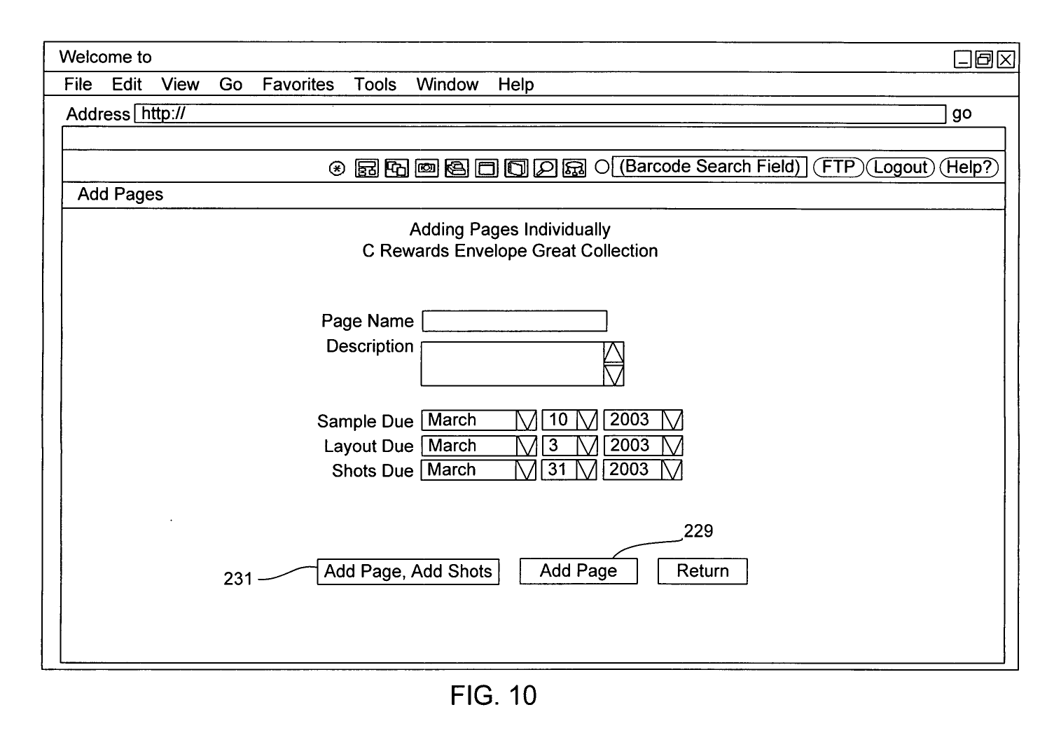

When a user selects add second level item editor button 206, server 12 prompts the user whether the user desires to add second level item listings individually or all at a time, and prompts the user to provide a location for placement of the second level listings. A user controls server 12 to add a second level listing after a last second level item listing in a second level item listings, before the last second level item listing, or after a particular second level item listing. When a user specifies whether to add second level items individually or at once and a location at which the user desires the second level listings to be placed, an add second level items editor is accessed from server 12. An add second level items editor displays second level items individually and the display includes fields presenting second level item attributes including a page name, a description of a page, a samples due date, a layout due date, and a shots due date, shown in FIG. 10.

A user can control server 12 to edit a second level item's attributes as desired, leaving fields blank or with default values. A second level item's attributes can also be edited at a later time, after a second level item has been created by server 12. Server 12 receives a user's selection of an add second level items button 229 and completes an addition of a second level item to a first level item. When server 12 receives a user's selection of an add second level items button 229, server 12 develops 66 (FIG. 3) a set of listings of pages describing a sample and any additional samples. Alternatively, server 12 receives a user's selection of a return button and provides access to a second level item list without adding a second level item. Alternatively, when a user selects an add second level items, add third level items button 231, server 12 associates a second level item with a first level item and associates a third level item to the second level item. When server 12 determines that a second level item is added, an add second level items editor is accessed from server 12. An add second level items editor displays a message confirming a successful addition of a second level item. An add second level items editor prompts a user to select between continuing to add second level items by editing fields and selecting a done adding second level items button to return to a second level item list.

An add second level items editor for adding multiple second level items generates fields which present second level items attributes, except for a barcode, and generates a field for a number of second level items to add. A user can control server 12 to edit a second level item attribute, as desired, leaving fields blank or with default values.

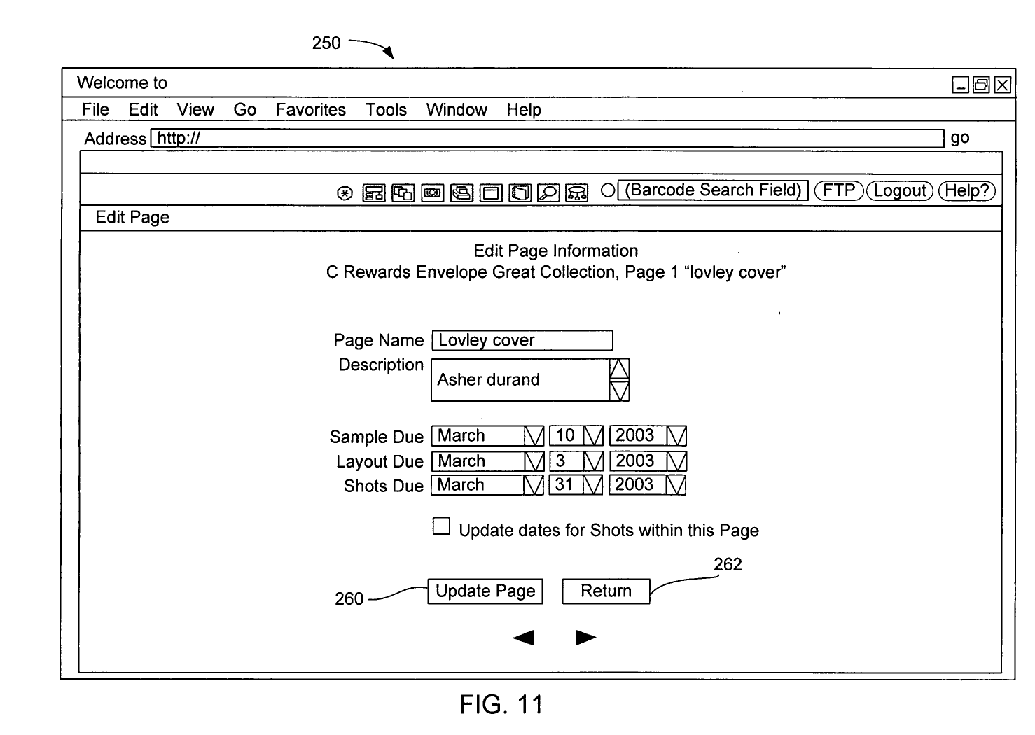

FIG. 11 shows an exemplary edit attributes page 250 that is generated by server 12 when edit button 208 (FIG. 9) is selected by a user. Server 12 receives a user's edit of a field, a selection of an update second level item button 260, and changes a second level item's attribute. Alternatively, server 12 receives a user selection of a return button 262 and provides access to second level item listings without updating a second level item's attribute.

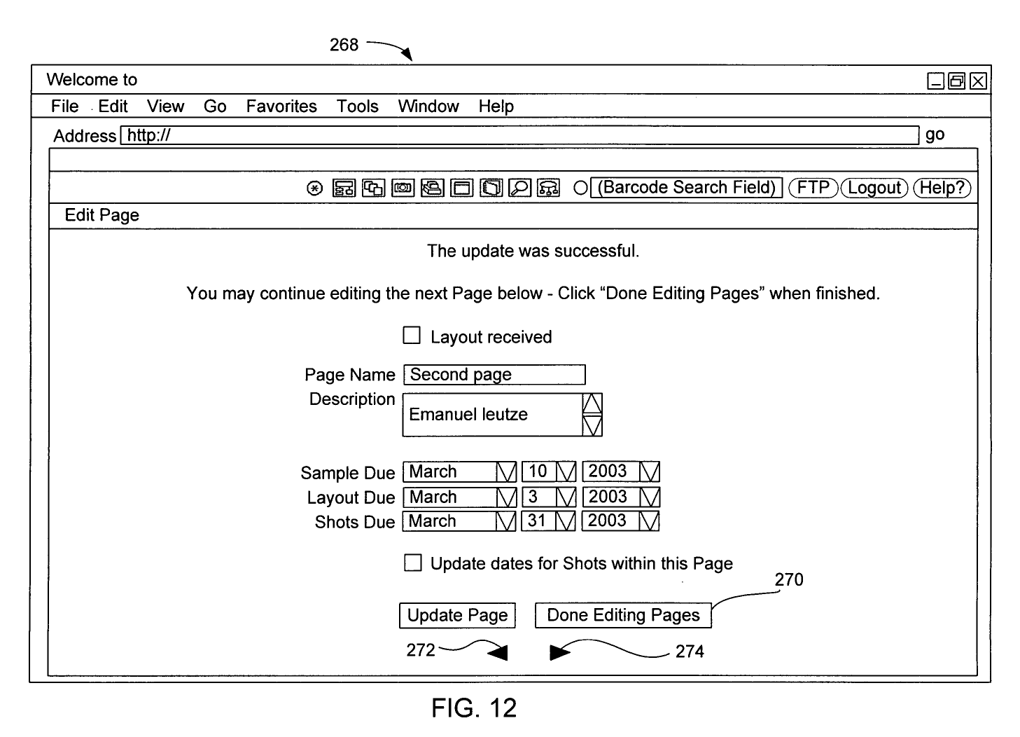

When a second level item's attributes are successfully updated, server 12 displays a message on an edit attributes screen 268, shown in FIG. 12, that the update is successful is shown and a done editing second level items button 270. Server 12 displays second level item attributes on edit attributes screen 268 and the second level item attributes belong to a next second level item listing sequentially in a plurality of second level item listings. A user continues to control server 12 to edit second level item listings in sequential order. A user can sequentially view second level item listings by selecting previous or next arrows 272 and 274. Alternatively, server 12 receives a user's selection of done editing second level items button 270 and provides access to a second level item listing without updating a second level item's attribute.

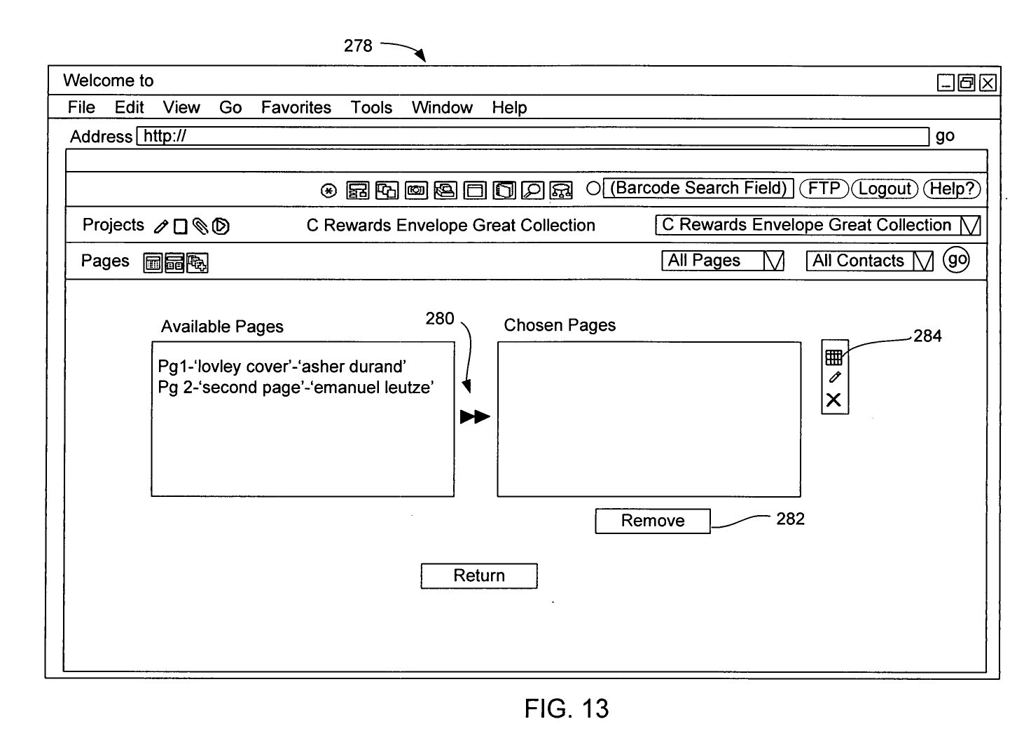

FIG. 13 shows an exemplary multiple list view 278 in which second level items are displayed by server 12. Multiple list view 278 is generated by server 12 when a user selects display second level items in a multiple list button 204 (FIG. 9). Multiple list view 278 allows editing operations to be performed on multiple second level items at the same time. All second level items listed in second level item list view 190 (FIG. 9) are shown in a left-side list in multiple list view 278 and are labeled as “Available Pages”. A user selects desired second level item listings from the left side list and selects a double arrow 280 between the left-side list and a right-side list. Server 12 adds selected second level items to the right-side list labeled, for instance, as “Chosen Pages”. When a user selects second level items in the right-side list and a remove button 282, server 12 removes the second level items from the right-side list. Server 12 displays a second level workflow builder button 284. When a user selects second level workflow builder button 284, server 12 initiates an editing process of second level items selected in the right side list.

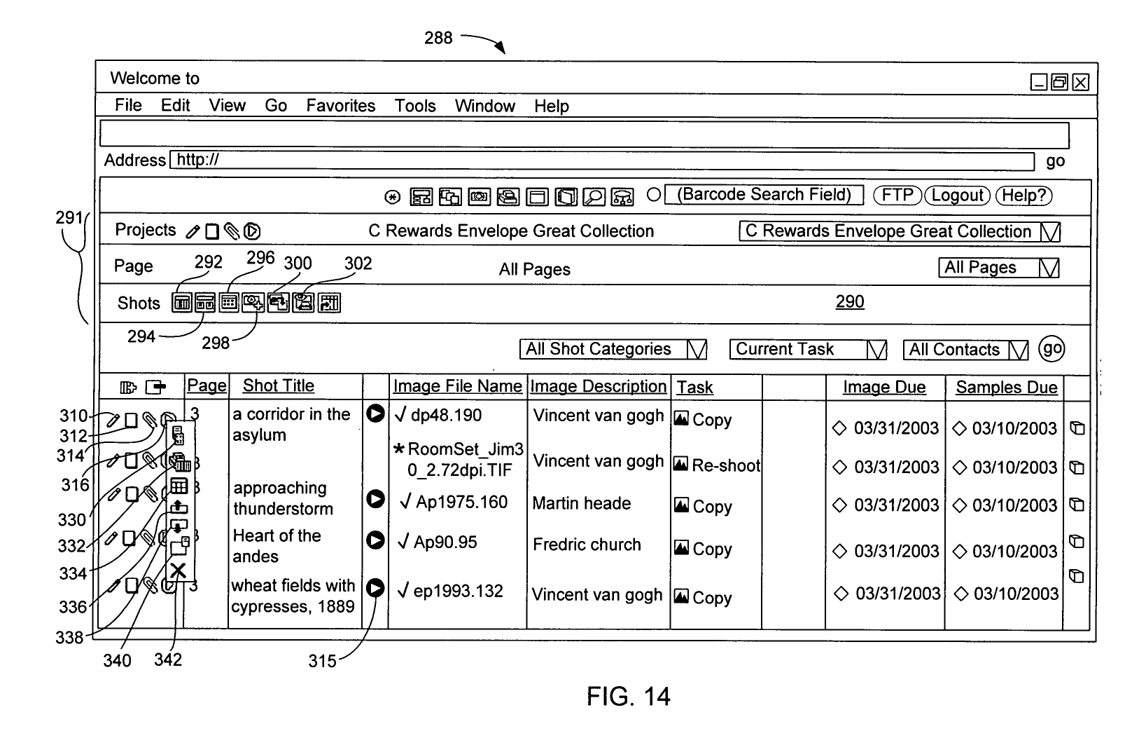

FIG. 14 shows an exemplary regular list view 288 of third level item listings displayed by server 12. Regular list view 288 includes third level item listings for all second level items in a selected first level item. Alternatively, third level item listings corresponding to either a single second level item or all first level items can be displayed by server 12. Moreover, optionally, server 12 displays third level item listings in a multiple list view or alternatively in a contact sheet view. A user can control server 12 to add, edit, and delete third level items from third level item listings.

Server 12 displays cascading menus 291 above third level item listings. An appearance of cascading menus 291 depends on whether a user has entered a third level item listing from a first level item listing or alternatively second level item listings. A user uses cascading menus 291 to access third level item listings from a first or alternatively a second level item listing. Cascading menus 291 include a path a user followed, a second level item, and/or first level items corresponding to a set of third level items.

Regular list view 288 includes a third level item list bar 290. Buttons on third level item list bar 290 include a display third level items in a regular list button 292, a display third level items in a multiple list button 294, a display third level items in a contact sheet button 296, an add third level items editor button 298, an auto-attach or auto-create third sub-level items button 300, and a create offline third level items list button 302. In one embodiment, each third level item includes multiple third sub-level items. For example, each shot includes multiple images, which are shot variations.

When a user selects display third level items in a regular list button 292, server 12 displays third level item listings. Server 12 organizes third level item attributes, such as, “image file name” and “image description”, of third level items into columns visible in regular list view 288.

At the left side of each third level item listing are a number of controls that include an edit button 310, a notes editor button 312, an attachments button 314, an add third sub-level items button 315, and a popup menu button 316. Edit button 310 has similar functionality as that of edit button 208 (FIG. 9) except that edit button 310 applies to third level items instead of second level items. Notes editor button 312 has similar functionality as that of notes editor button 210 (FIG. 9) except that notes editor button 312 applies to third level items instead of second level items. Attachments button 314 has similar functionality as that of attachments button 212 (FIG. 9) except that attachments button 314 applies to third level items instead of second level items.

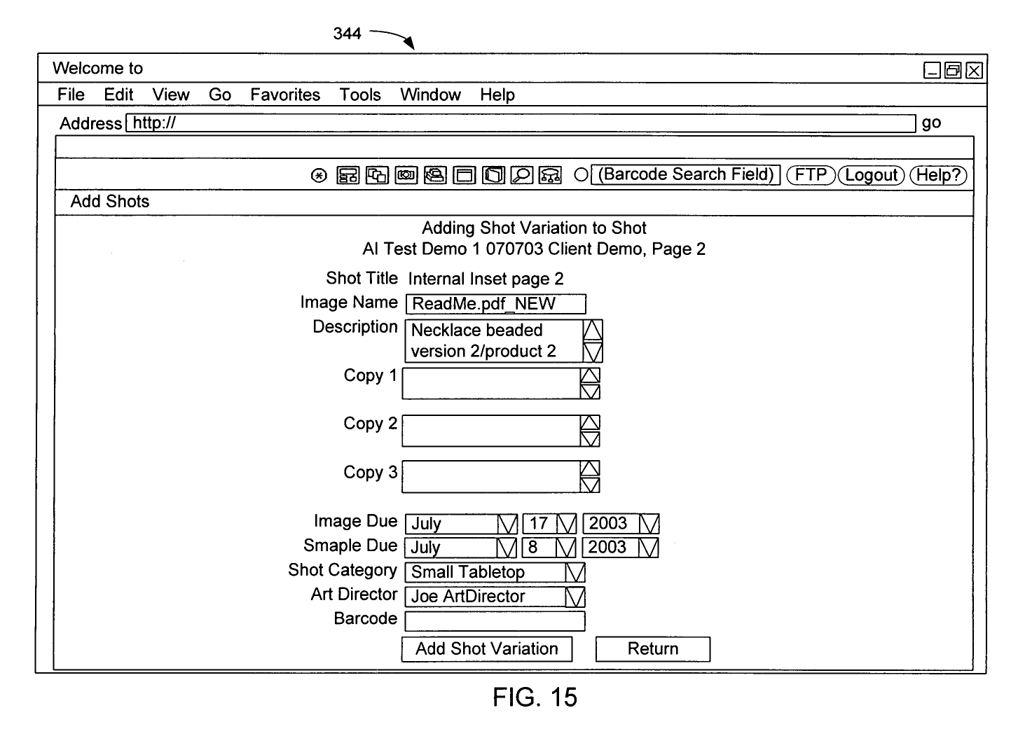

When a user selects add third sub-level items button 315, an editor that allows a user to add third sub-level items to a third level item is accessed from server 12. When add third sub-level items button 315 is selected, server 12 displays an add third sub-level item to third level item screen 344, shown in FIG. 15. Examples of third sub-level item attributes of third sub-level items include a shot title, an image name, a description of an image, a description of multiple copies of the image, an image due date, a sample due date, a shot category, an art director name, and a barcode of the image.

Referring to FIG. 14, when a user selects popup menu button 316, server 12 displays a view fourth level items for this third level item button 330, an assign fourth level items to this third level item button 332, a third level item workflow builder button 334, an upload a file for this third level item button 336, a download this file to a user's computer button 338, an attach an uploaded file to this third level item button 340, a copy/move this third level item button, and a delete this third level item button 342. Server 12 receives a user's selection of view fourth level items for this third level item button 330 and provides access to a fourth level item list with fourth level item information specific to a third level item. When a user selects assign fourth level items to this third level item button 332, an assign fourth level item editor is accessed from server 12.

When a user selects fourth level item workflow builder button 334, a workflow builder that allows the user to edit scheduled tasks and contacts specific to a third level item is accessed from server 12. Server 12 receives a user's selection of upload a file for this third level item button 336 and generates an upload file popup window. When a user selects download this file to a user's computer button 338, a download file popup window is produced by server 12. Server 12 receives a user's selection of attach an uploaded file to this third level item button 340, server 12 creates an attach file popup window. Server 12 provides access to a copy/move editor when a user selects a copy/move this third level item button. When a user selects delete this third level item button 342, server 12 removes a third level item from third level item listings.

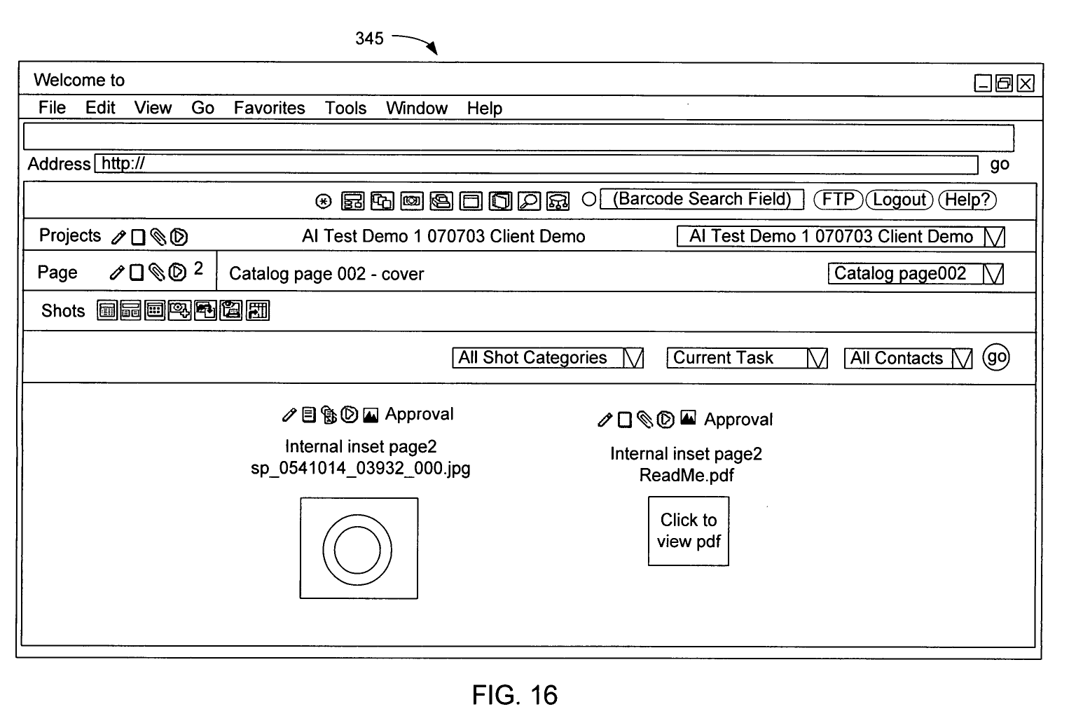

Display third level items in a multiple list button 294 functions in a similar manner as that of display second level items in a multiple list button 204 (FIG. 9) except that display third level items in a multiple list button 294 applies to third level items instead of second level items. When a user selects display third level items in a contact sheet button 296, server 12 displays all third level items listings in a contact sheet view 345, shown in FIG. 16, including thumbnail third level items.

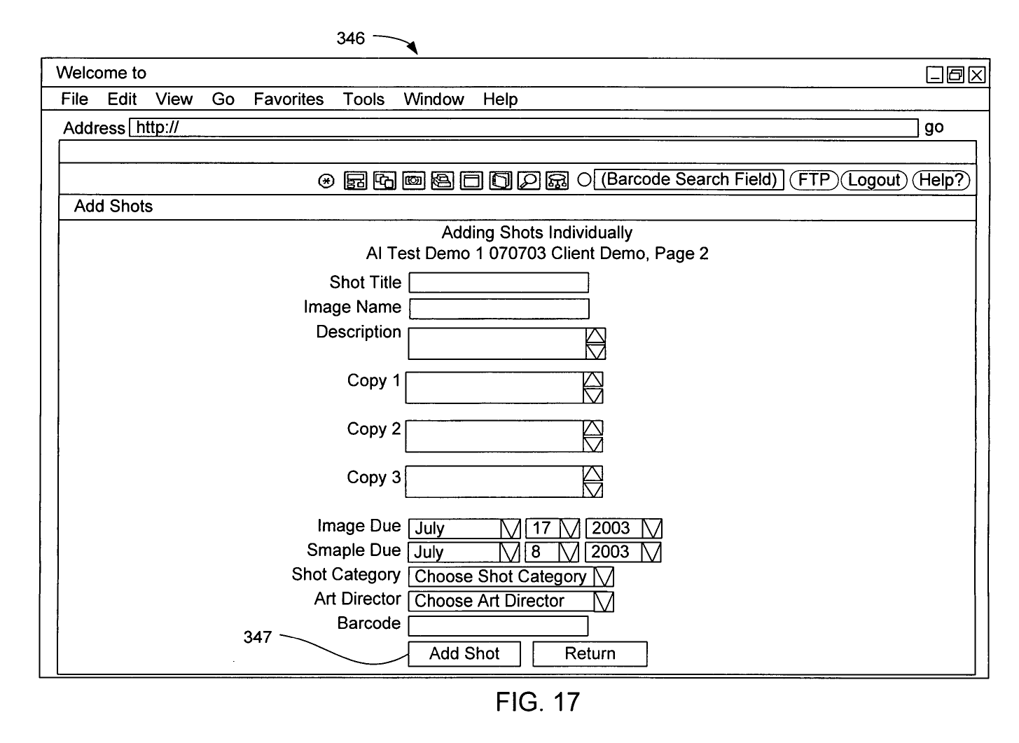

Referring to FIG. 14, add third level editor button 298 has similar functionality as that of add second level item editor button 206 (FIG. 9) except that add third level item editor button 298 applies to third level items instead of second level items. When a user selects add third level item editor button 298, server 12 displays an add third level items screen 346, shown in FIG. 17, including third level item attributes. Examples of third level item attributes include a shot title, an image name, a description of a shot, a description of copies of the shot, an image due date, a sample due date, a shot category, an art director name, and a barcode of the shot. When a user controls server 12 to add or editing level items, server 12 restricts fields in which attributes of the level items are entered so that duplicate values of the attributes cannot be entered in the fields. For example, when a user controls server 12 to individually add or edit a level item, server 12 checks for duplicate entries of values of attributes within a first level item for all restricted fields. When server 12 detects duplicate entries of values of attributes within a level item, server 12 displays a message to a user informing the user that one of the values is not unique. A user controls server 12 to correct a value that is not unique and resubmit the value to server 12.

Server 12 receives a user's selection of an add third level item button 347 and adds third level items to a particular second level item or alternatively to a first level item. When a user selects add third level item button, server 12 generates 64 (FIG. 3) a set of listings of shots of a sample and additional samples.

A user controls server 12 to assign a third level item category to a third level item. Server 12 receives a user's selection of administration menu button 114 (FIG. 5) and creates third level item categories. A user selects address book button 110 (FIG. 5) to access an address book. A user controls server 12 to edit a client in an address book. Server 12 assigns third level item categories to a client by editing the client in an address book.

Referring to FIG. 14, when auto-attach third sub-level items button 300 is selected by a user, server 12 attaches a previously uploaded third sub-level item file to an existing third level item. Server 12 compares uploaded third sub-level item filenames from within an FTP directory to filenames of third level items within a current level item, such as a first level item. When a match is found, a third sub-level item file from within an FTP directory is attached to a corresponding third level item.

When auto-create third sub-level items button 300 is selected by a user, server 12 creates third sub-level items from uploaded third sub-level item files. When auto-create third sub-level items button 300 is selected, server 12 provides access to multi-select boxes. A user accesses multi-select boxes and selects third sub-level item files, which are auto-created by server 12. When a user selects third sub-level item files and a button, server 12 creates one third sub-level item for each selected third sub-level item file. Server 12 sets a third sub-level item title and a third sub-level item file name to a name of an uploaded third sub-level item file, and creates large and small third sub-level items. Server 12 creates a third sub-level item within a specific second level item. Alternatively, server 12 creates a third sub-level item within a first level item when the first level item is not associated with second level items. When server 12 determines that a third sub-level item cannot be auto-created in association with a first or a second level item, server 12 grays-out auto-create third sub-level items button 300. A user selects create offline third level item list button 302. When a user selects create offline third level item list button 302, server 12 creates a printable version of a level item, such as third level item listings, fourth level item listings, notes or second level item listings related to a first level item.

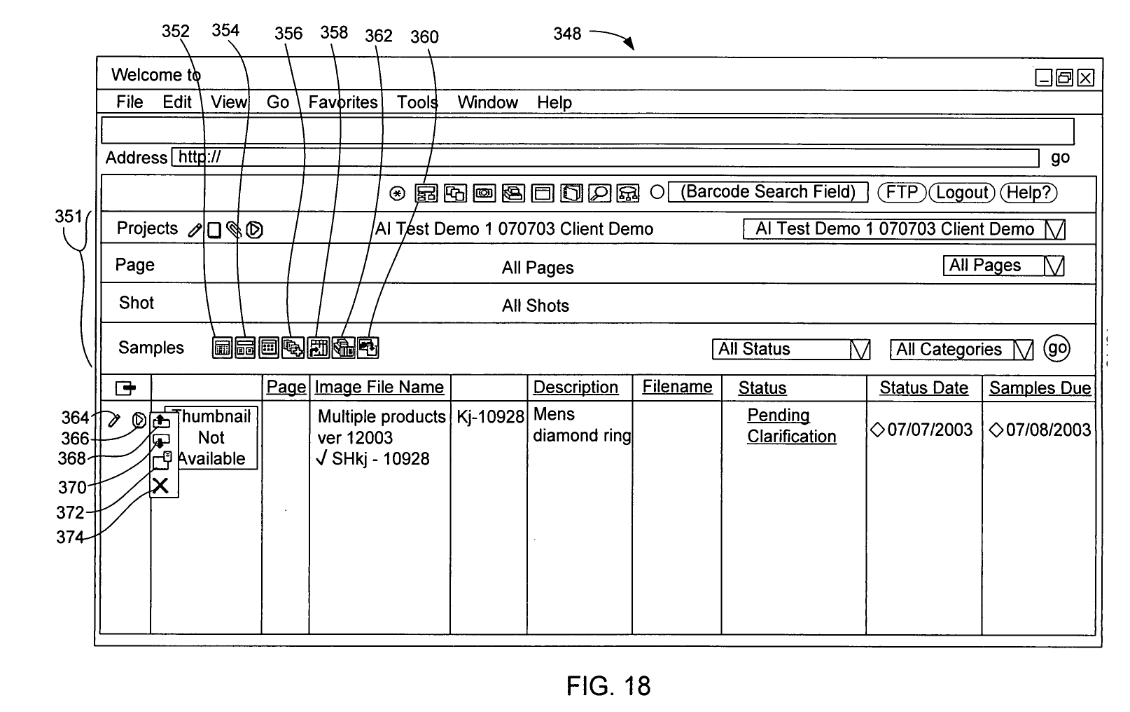

FIG. 18 shows an exemplary fourth level item listings view 348 that includes fourth level item listings. A user uses cascading menus 351 to access a fourth level item listing from a first level item listing, a second level item listing, or alternatively a third level item listing. When a user accesses fourth level item listings via a first level item listing, a second level item listing, or a third level item listing, cascading menus 351 above the fourth level item listings include a context, such as the first level item listing, the second level item listing, or the third level item listing used to access the fourth level item listings.

Fourth level item listings view 348 includes a fourth level item list bar 350. Fourth level item list bar 350 includes a display fourth level items in a regular list button 352, a display fourth level items in a multiple list button 353, an add fourth level item editor button 356, an import fourth level items button 358, an auto-attach or auto-create from uploaded fourth level item files button 360, and an assign fourth level item button 362.

When a user selects display fourth level items in a regular list button 352, server 12 displays fourth level items listings and displays each fourth level item listing in a corresponding horizontal line. Server 12 filters fourth level item listings by contact, with a default being all contacts. Server 12 organizes fourth level item attributes, such as, a title of a sample, a description of the sample, a filename of an image associated with the sample, a status of the sample, a status date, and a sample due date into columns.

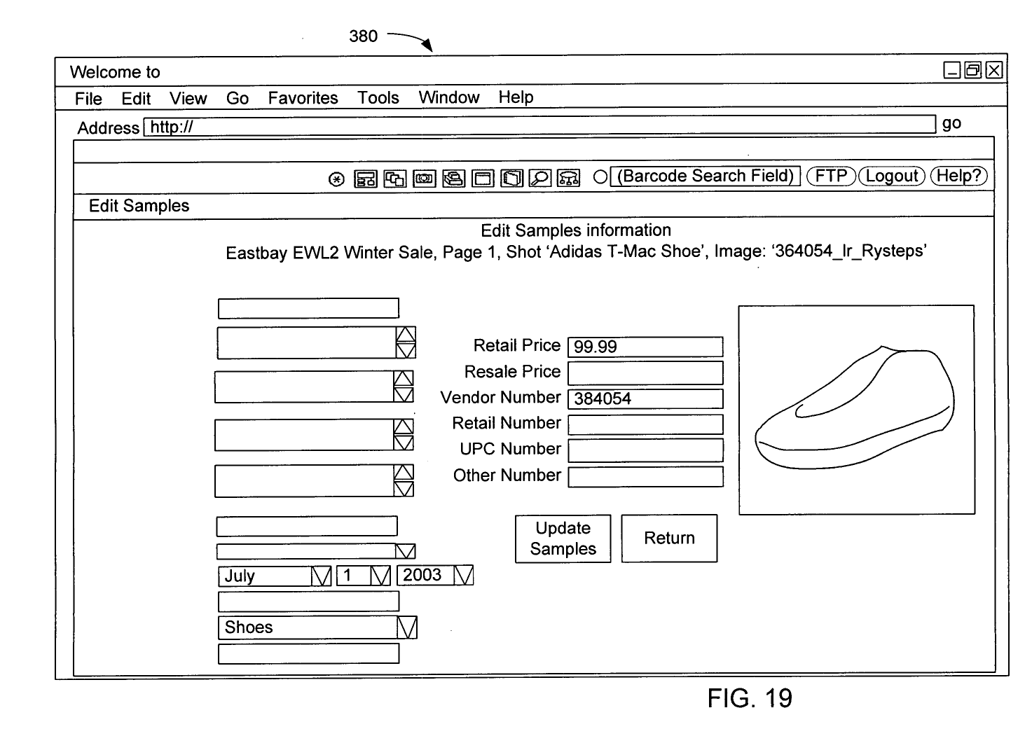

At the left side of each fourth level item listing are controls that include an edit button 364. Edit button 364 has similar functionality to that edit button 208 (FIG. 9) associated with second level items except that edit button 364 applies to fourth level items instead of second level items. When edit button 364 is selected by a user, server 12 generates an edit attribute screen 380, shown in FIG. 19. A user controls server 12 to edit fourth level item attributes, such as, a title of sample, a description of the sample, a description of copies of the sample, an image file name associated with the sample, a status of the sample, a status date of the sample, location details of the sample, a category of the sample, a barcode of the sample, a retail price of the sample, a resale price of the sample, a vendor number of the sample, a retail number of the sample, a universal product code (UPC) number of the sample, and other number of the sample, shown on edit attribute screen 380.

Fourth level item attributes are added in a similar manner in which third level item attributes are added. When fourth level item attributes are added, server 12 creates 62 (FIG. 3) a set of listings of a sample and additional samples.

Referring to FIG. 18, fourth level item listings view 348 includes a popup menu button 366. When a user selects popup menu button 366, server 12 generates a popup menu that includes an upload a file for this fourth level item button 368, a download this file to a user's computer button 370, an attach an uploaded file to this fourth level item button 372 and an un-assign/delete this fourth level item button 374. Server 12 receives a user's selection of upload a file for this fourth level item button 368 and creates an upload file popup window. The upload file popup window is used to upload a file from a user's computer, such as workstation 52 (FIG. 2), to application server 24 (FIG. 2) remote from the computer. When a user selects download this file to a user's computer button 370, server 12 creates a download popup window and the user uses the download popup window to download a file from application server 24 (FIG. 2) remote from a user's computer, such as workstation 52 (FIG. 2), to the computer. Server produces an attach file popup window upon receiving a user's selection of uploaded file to this fourth level item button 372. When a user views a fourth level item from a context outside a specific level, such as a first level, and selects un-assign/delete this fourth level item button 374, server 12 removes the fourth level item from fourth level item listings. A user that is provided permission can delete fourth level item listing. A user views a fourth level item from a context of a level item, such as a first, a second, or a third level item. When a user views a fourth level item from a context of a level item and selects un-assign/delete this fourth level item button 374, server 12 un-assigns the fourth level item from the level item.

A user selects display fourth level items in a regular list button 352. A selection of display fourth level items in a regular list button 352 provides similar functionality as that generated by selecting display second level items in a regular list button 202 (FIG. 9) except that display fourth level items in a regular list button 352 applies to fourth level items instead of second level items. A user selects add fourth level item editor button 356. A selection of add fourth level item editor button 356 provides similar functionality to that generated by selecting add second level item editor button 206 (FIG. 9) except that add fourth level item editor button 356 applies to fourth level items instead of second level items.

When import fourth level items button 358 is selected by a user, server 12 generates a display and the user can type or browse a filename on the display to import files to be associated with a fourth level item. Server 12 imports files to be associated with a fourth level item. When a user selects auto-attach or auto-create from uploaded fourth level item files button 360, server 12 attaches a previously uploaded file to an existing fourth level item. System 22 compares uploaded fourth level item filenames from within an FTP directory to filenames of fourth level item files within a current first level item. When a match is found, a file is attached to a corresponding fourth level item.

When auto-attach or auto-create from uploaded fourth level item files button 360 is selected, server 12 creates, from uploaded fourth level item files, a fourth level item within a level item, such as a third level item or a first level item. When auto-attach or auto-create from uploaded fourth level item files button 360 is selected, server 12 provides access to multi-select boxes. A server 12 receives a user's selection of fourth level item files from multi-select boxes and auto-creates the fourth level item files. When a user selects fourth level item files and selects a button, server 12 creates a fourth level item for each selected fourth level item file. When a user selects fourth level item files and selects a button, server 12 sets a fourth level item title and fourth level item file name to a name of an uploaded fourth level item file, and creates large and small fourth level items. Server 12 creates a fourth level item within a level item, such as a third level item, or alternatively creates the fourth level item within a first level item when the first level item does not have second level items. When server 12 determines that server 12 does not include first, second, or third level items, server 12 grays-out auto-attach or auto-create from uploaded fourth level item files button 360.

When both a fourth level item and a third level item are stored in disk storage unit 34 and a user selects assign fourth level item button 362, server 12 creates an association between the fourth level item and the third level item. Server 12 assigns a fourth level item to a third level item when a user selects assign fourth level item button 362.

Server 12 filters first level item listings, second level item listings, third level item listings, fourth level item listings, and contacts or people according to a user's role's permission levels. When a user notices differences between level item listings when the user logs into server 12 and level item listings another user sees during access to server 12, the differences are due to differences in permission levels of the users.

A user controls server 12 to attach notes to level items, such as first level items, second level items, and third sub-level items. Server 12 provides access to notes from a level item listing, a first level item listing, a second level item listing and a third level item listing. A user can respond to a note and the user controls server 12 to edit the note. An icon, such as edit button 124 (FIG. 5), on the left side of a level item listing indicates whether or not a note exists for the listing. When notes are not present for a level item listing and a user selects an icon, an editor is accessed from server 12 for adding a note. When server 12 includes notes attached to a level item listing and a user selects an icon, server 12 provides access to a notes list associated with the level item listing for viewing, responding, and/or editing any note in the notes list.

Server 12 displays and filters notes according to a user's permission level. When a user logs into system 22 and notices differences between a notes list and another notes list accessed from server 12 by another user, the differences are due to differences in permission levels of the users.

A user takes a path to access one of edit buttons 124 (FIG. 5), 208 (FIG. 9), 310 (FIG. 14), 364 (FIG. 18). Server 12 determines notes and displays the notes in a notes list based on a path taken by a user. For example, when a user accesses a notes list from a third level item listing, server 12 displays notes for a third level item. As another example, when a user selects a value from a drop down selection control, server 12 displays notes for a second level item corresponding to a third level item or alternatively displays notes for a first level item corresponding to the third level item. As yet another example, when a user accesses a notes list from a first level item listing, server 12 displays notes for a first level item. As still another example, server 12 receives a user's selection and displays notes for second level items in a first level item or alternatively displays notes for third level items corresponding to the first level item.

Server 12 associates, such as hyperlinks, a set of buttons with each notes list and the buttons allow a user to reply to a note, edit a note, or delete a note. A user selects a reply to note button and controls server 12 to reply to a note. A user can control server 12 to edit text within a note and a user cannot control server 12 to edit a date on which the note is created. A user selects an add reply button and controls server 12 to complete an addition of a reply to a note. Alternatively, when a user selects a return button, server 12 provides access to a notes list without changing a note. When server 12 determines that a reply to a note is added, server 12 re-displays a notes list with the reply.

Server 12 attaches various kinds of text and files, such as third or fourth level item files, to level items. A user access an attachment from a level item listing, such as a first level item listing, a second level item listing, a third level item listing, or a fourth level item listing.

Server 12 filters attachments according to a user's permission level. When logging into server 12 a user notices differences between an attachments list the user sees and another attachments list visible to another user that accesses server 12, the differences are due to differences in permission levels of the users. An attachments list includes a set of listings of attachments.

When a user selects attachments button 126 (FIG. 5), server 12 generates an attachments list view including an attachments list. Alternatively, a user selects an attachments button from a second level item listing or a third level item listing. Server 12 determines attachments and displays the attachments based on a path taken by a user to access an attachments list. For example, a user entering an attachments list from a third level item listing sees attachments attached to the third level item listing. Server 12 associates each attachments list with a delete button. When a user selects a delete button associated with an attachments list, server 12 deletes an attachment.

Server 12 receives a user's selection of add attachments button 131 (FIG. 5) and an attachments editor is accessed from server 12. When a user selects add attachments button 131 (FIG. 5), server 12 lists a first level item with a message that no attachments have been entered corresponding to the first level item. Server 12 receives a user's selection of a button and continues to add an attachment. Alternatively, server 12 receives a user's selection of a return button and provides access to a level item listing without adding an attachment. When server 12 determines that an attachment is added, server 12 re-displays an attachments list with the attachment.

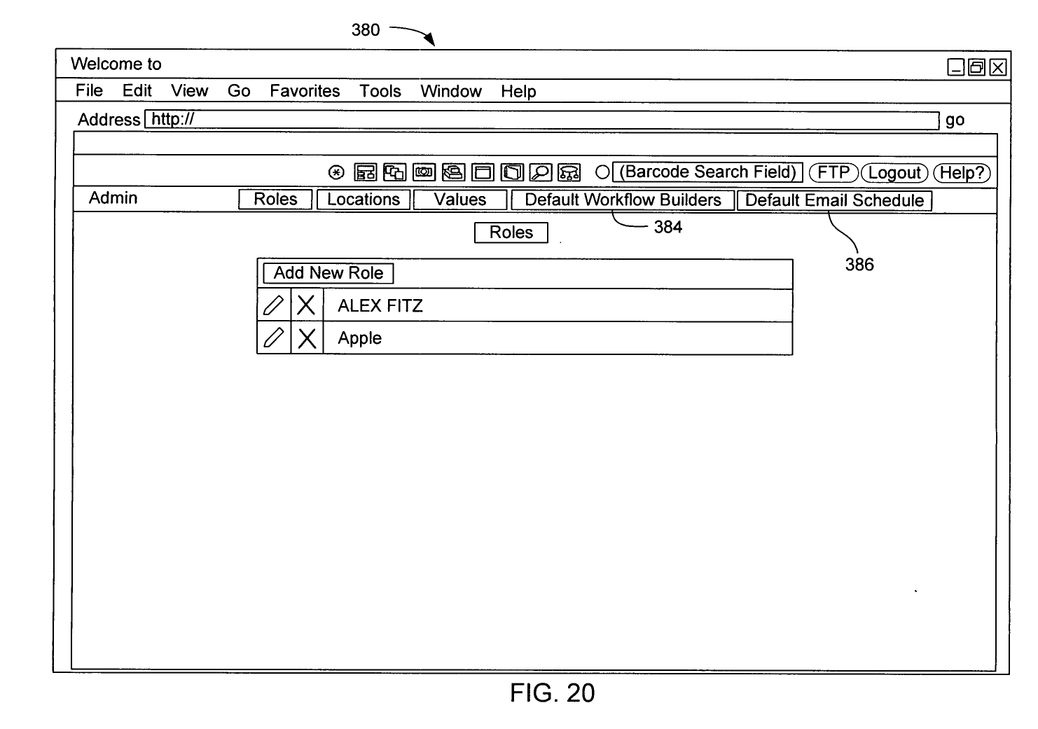

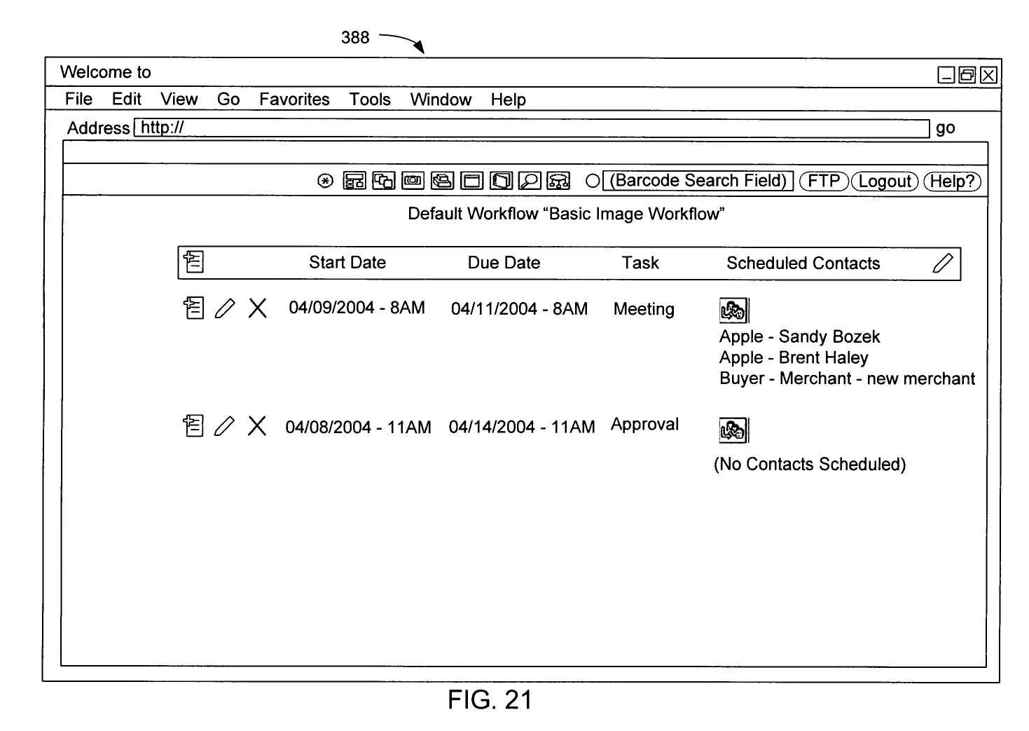

FIG. 20 shows an exemplary administration screen 382 that is generated by server 12 when a user selects administration menu button 114 (FIG. 5). Server 12 provides access to a workflow builder from various locations such as a first level item listing, a second level item listing, a third level item listing, a fourth level item listing, or when a user selects a default workflow builder button 384. A workflow builder accessed from server 12 schedules a flow of tasks involved in creation of level items, such as third level items. When a user selects default workflow builder button 384, server generates a default workflow screen 388, shown in FIG. 21.

A user controls server 12 to change a workflow, such as, for example, a start date, a due date, tasks, or contacts at a first level, on default workflow screen 388. When a user controls server 12 to change a workflow at a first level, server 12 can change level item listings at a second level and a third level. As an example, when a change is made to a due date of a project, the change made affects attachments, pages, images, or samples that server 12 associates with the project. When a user controls server 12 to change a workflow at a second level, server 12 can change level item listings at a third level. A user can change a workflow at a third level. When a user controls server 12 to change a workflow at a third level, server 12 can change third level item listings When a user controls server 12 to change a workflow shown on default workflow screen 388, server 12 can change a default workflow of a first level item master schedule that is followed to create first level items.

When server 12 determines differences between a first level item master schedule providing scheduling for all first level items and a specific level item's schedule, server 12 prompts a user that there are tasks at a level, such as a first level or a third level, that deviate from the first level item master schedule. Moreover, server 12 determines differences between a first level item master schedule and a specific level item's schedule, and provides a user with selections. When server 12 provides access to a workflow builder from a first level item listing and determines that tasks at either a second level or a third level deviate from a first level item's workflow, server 12 prompts a user to select one of a first set of options. The first set of options include editing tasks within a workflow builder template that is used when creating second level items or third level items within a first level item, editing tasks that are common in all workflows within the first level item, and replacing all existing workflows with a workflow builder template for the first level item. When server 12 provides access to a workflow builder from a second level item listing and determines that tasks at a third level deviate from a second level item's workflow template, server 12 prompts a user to select from a second set of options. The second set of options include editing a workflow builder template used when creating third level items within a second level item, editing tasks that are common in all workflows within the second level item, and replacing all existing workflows with a workflow builder template for the second level item.

When server 12 determines differences between a first level item master schedule and a specific level item's schedule and a user makes a selection, server 12 displays a list of tasks with a task due date, a task name, and contacts. When no contacts are scheduled for a particular task, server 12 displays a note stating that no contacts are scheduled. A user controls server 12 to perform editing operations, such as, add, edit, delete, or assigning contacts to a task. A user accesses a workflow builder from a level item listing. When a user accesses a workflow builder from a level item listing and selects a return button, the user accesses the level item listing.

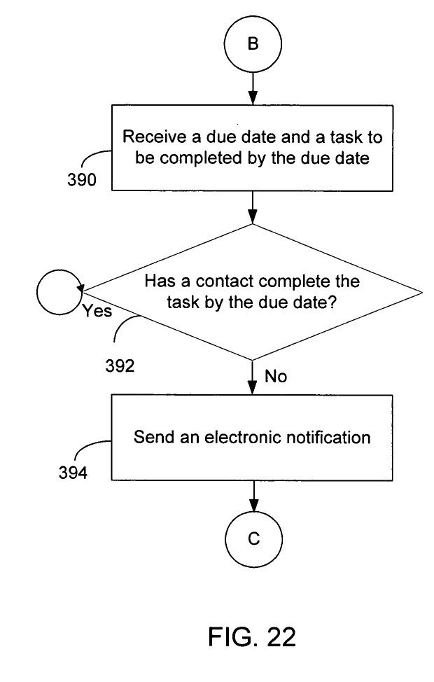

FIG. 22 is a flowchart of another embodiment of method 60 for managing information at various levels. Method 60 includes receiving 390 a due date and a task to be completed by the due date. Method 60 also includes determining 392 whether a contact has completed a task by a due date and sending 394 an electronic mail notification upon determining that the contact has not completed the task by the due date.

When a user selects first level item email scheduler button 150 (FIG. 7) associated with a first level item, server 12 provides access to an email scheduler editor. Alternatively, when a user selects default email scheduler button 384 (FIG. 20), an email scheduler is accessed from server 12. A user can access an email scheduler editor from a first level item and change an email schedule of the first level item. Alternatively, a user accesses an email scheduler editor from administration screen 382 (FIG. 20) and changes a default email schedule of all first level items within server 12. An email scheduler editor accessed from server 12 determines a timing of occurrence of specific events and allows scheduling of emails to be sent when the specific events occur.

Server 12 receives 390 a due date and a task to be completed by the due date. Server 12 processes events due in the past by determining 392 whether a contact has completed a task by a due date selected by a user. Server 12 sends 394 an electronic mail notification upon determining that the contact has not completed the task by the due date. For example, server 12 processes events due in the past and sends a past-due events email periodically, such as, for example, each night, until server 12 determines that the events are completed by a contact. Optionally, server 12 processes events due in the past and sends a past-due events email once.

For events due in the past, a user also controls server 12 to send a days-due-within email including a number of days in which a task is due. A user controls server 12 to edit past-due events and provide another due date to complete the past-due events. When a user selects an icon on the left side of level item, such as a first, a second, a third, or a fourth level item, server 12 provides access to a choose contacts editor. A user accesses a choose contacts editor and designates people for receiving email from server 12 upon occurrence of a specific event. In one embodiment, when a user controls server 12 to create a second level item, server 12 immediately sends a level item create event email.

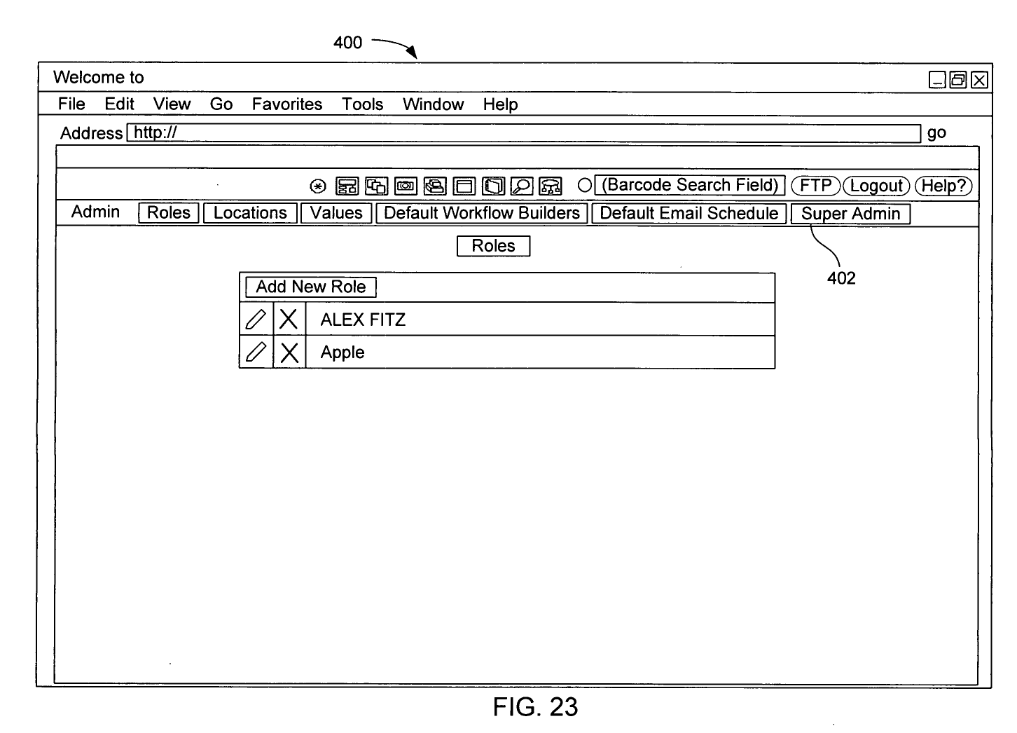

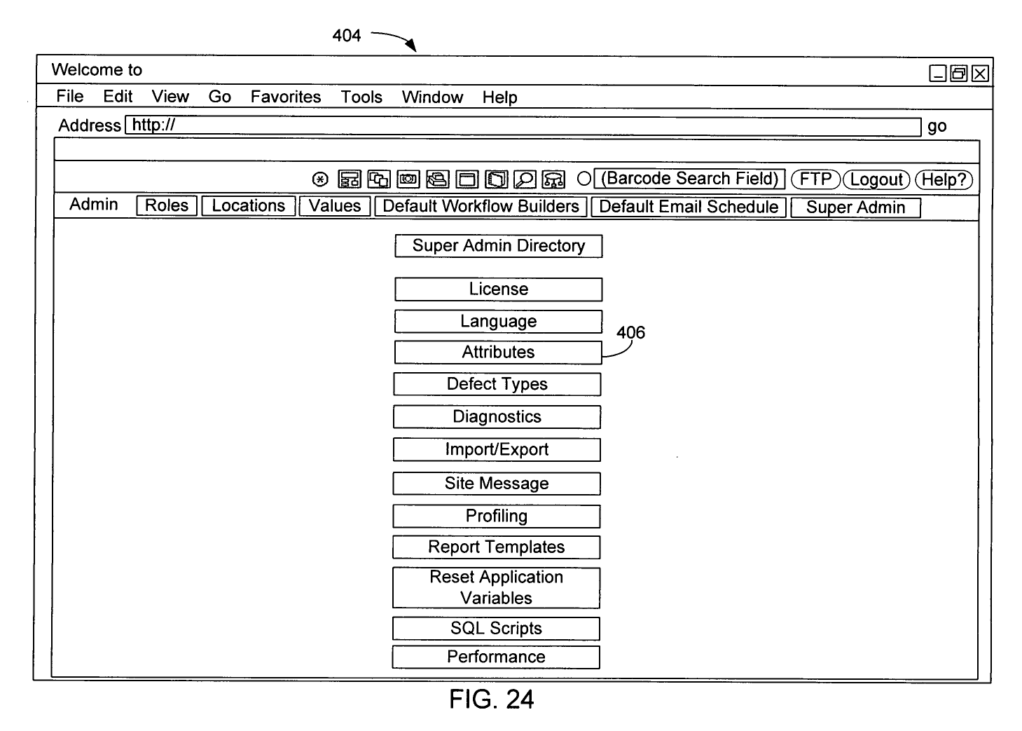

FIG. 23 shows an exemplary administration screen 400 generated by server 12 when a user selects administration menu button 114 (FIG. 5). When a user selects a super administration button 402, server 12 generates a directory screen 404, shown in FIG. 24. In one embodiment, server 12 displays super administration button 402 (FIG. 23) to users that are provided permission. Server 12 does not provide access to other users that do not have permission to access super administration functions such as adding, editing, and deleting attributes.

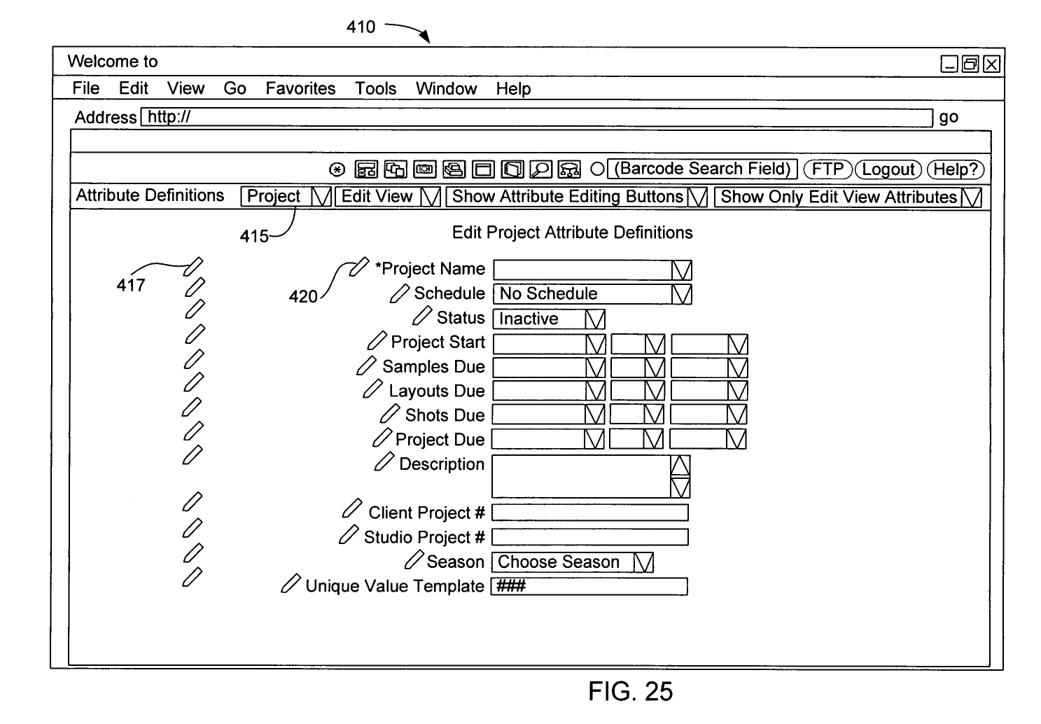

Directory screen 404 includes an attribute button 406. When a user selects attributes button 406, server 12 generates an edit first level item attribute definitions screen 410, shown in FIG. 25, that includes first level item attributes. Second level item attributes, third level item attributes, fourth level item attributes, or any other processes, such as tasks, are accessed from server 12 when a user selects an option from a drop down menu. An option from a drop down menu is generated when a user selects a field 415. A user controls server 12 to edit attributes or add additional attributes. Server 12 receives a user's selection of an add attribute button 417 and adds an attribute under an existing attribute. For example, an attribute can be added under an attribute “project name” by selecting add attribute button 417. As another example, an attribute such as a supervisor that manages a particular project can be added.

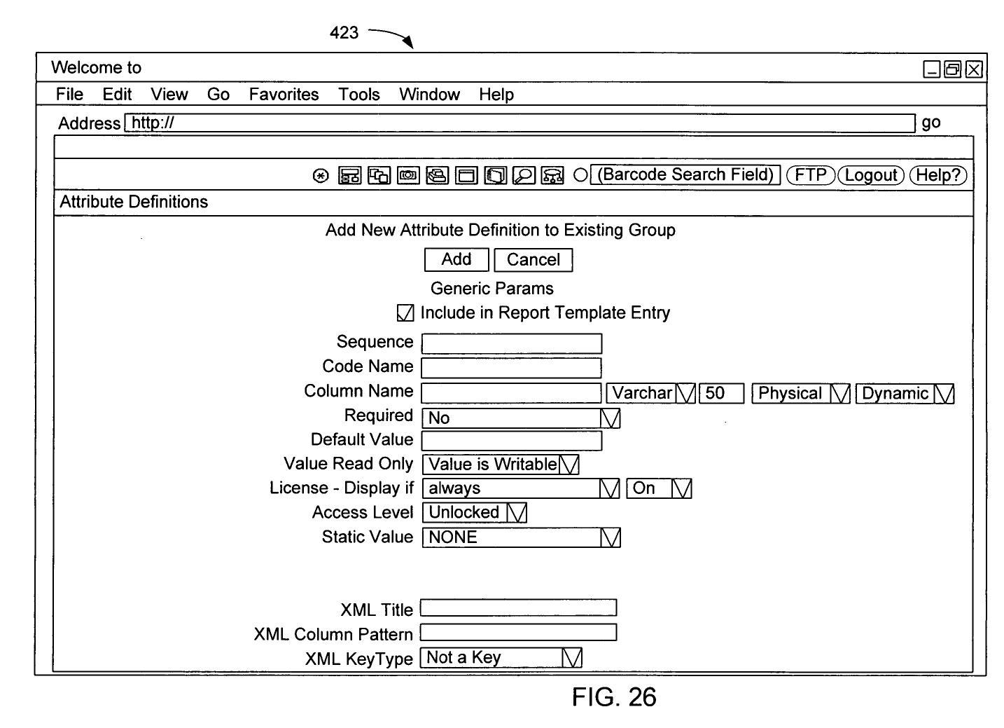

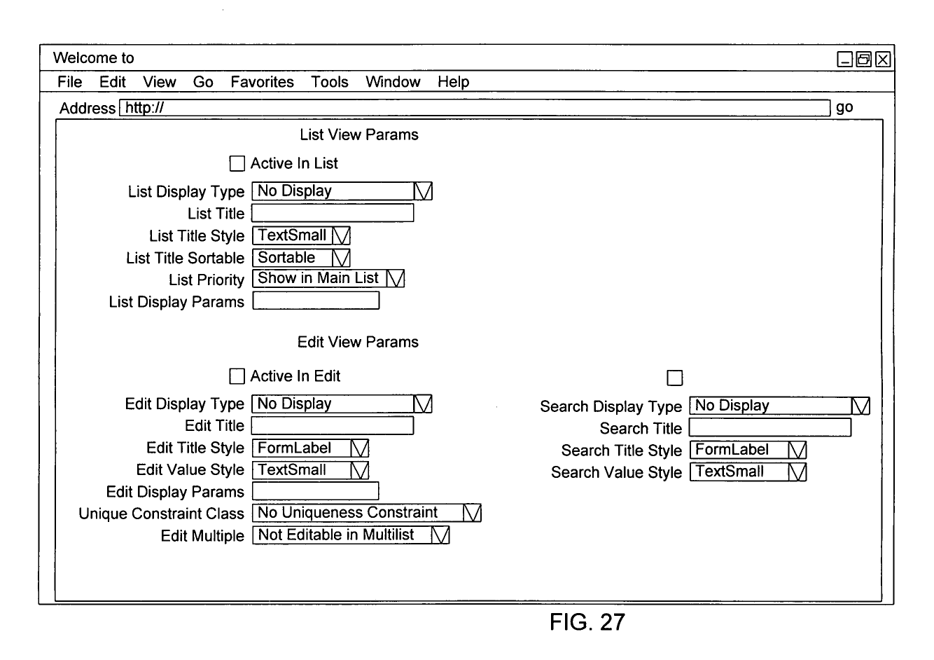

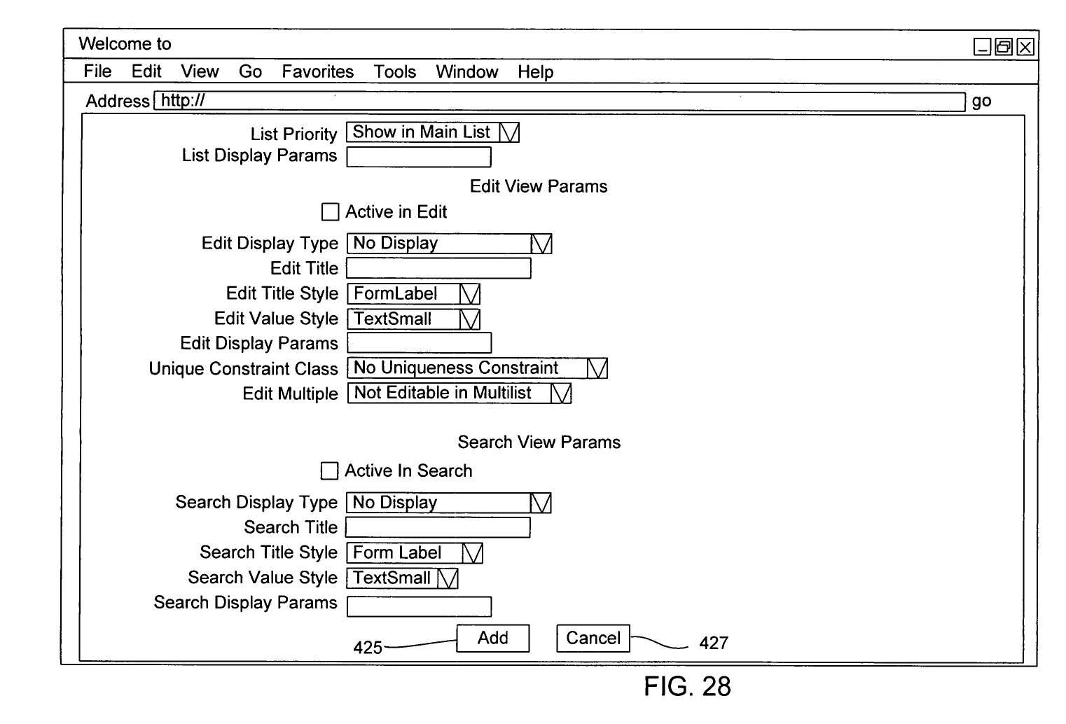

When a user selects add attribute button 417, server 12 generates an add attribute screen 423, shown in FIGS. 26, 27, and 28. Add attribute screen 423 includes fields for entering generic parameters, such as a codename of an attribute, fields for entering import/export parameters, fields for entering list view parameters, fields for entering edit view parameters, such as an edit display type parameter, and fields for entering search view parameters. Server 12 receives an edit display type parameter from a user and displays an attribute in a particular format or appearance. An appearance is one of many parameters of an attribute of any of first, second, third, or fourth level items. A user controls server 12 to add, edit, or delete a particular appearance of attributes in a list or a report. When a user selects parameters of an attribute to be added and selects an add button 425, server 12 adds, under an existing attribute, the attribute having the parameters. Alternatively, server 12 cancels an addition of an attribute upon receiving a user's selection of a cancel button 427.

Referring to FIG. 25, when a user selects an edit attribute button 420, the user controls server 12 to edit parameters, shown in FIGS. 26, 27, and 28, and corresponding to an attribute, such as “project name”. Server 12 receives a user's selection of a delete attribute button, such as delete this first level item button 152 (FIG. 7), and deletes an attribute.

Second, third, or fourth level item attributes can be added in a manner similar to that described above with reference to first level item attributes. Moreover, parameters corresponding to second, third, or fourth level item attributes are similar to parameters corresponding to first level item attributes. Moreover, an existing second, third, or fourth level item attribute can be edited in a manner similar to that described above with reference to first level item attributes. A deletion of an existing second, third, or fourth level item attribute is similar to a deletion, described above, of first level item attributes.

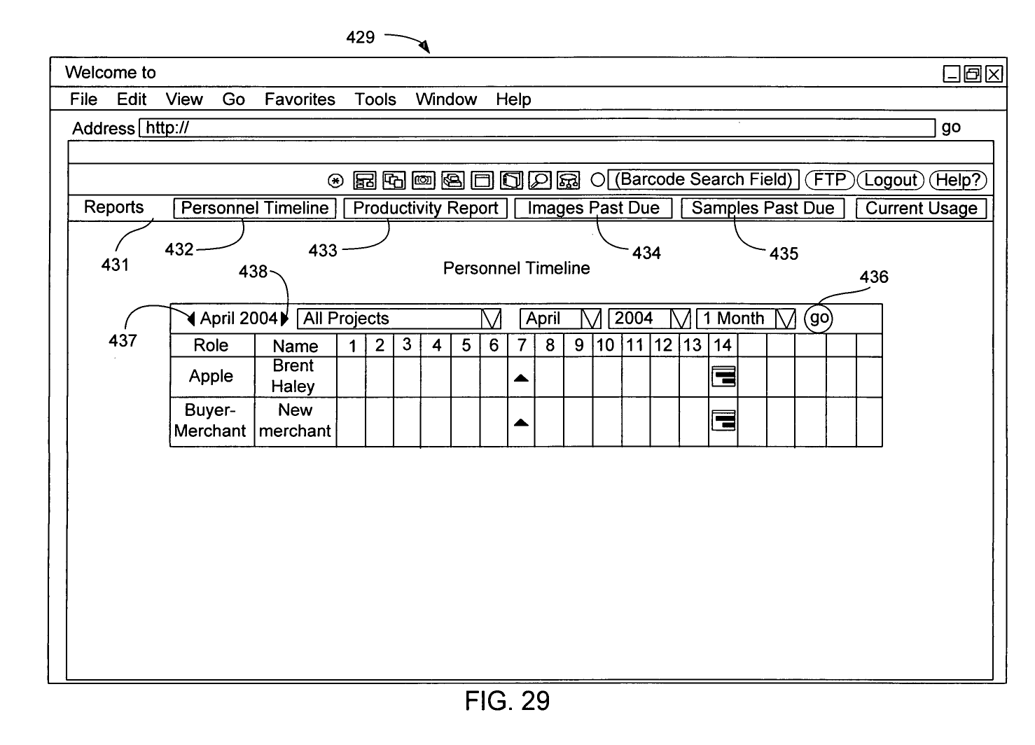

FIG. 29 is an exemplary personnel timeline report 429. Personnel timeline report 429 includes a reports bar 431. Server 12 generates reports bar 431 when a user selects reports menu button 108 (FIG. 5). Reports bar 431 includes a personnel timeline button 432, a productivity report button 433, a third level items past due button 434, and a fourth level items past due button 435. Server 12 generates personnel timeline report 429 upon receiving a user's selection of personnel timeline button 432.

Personnel timeline report 429 includes workloads of users for a first level item or for all first level items. When a first level item is selected by a user, server 12 displays users, such as, “Brent Haley”. Personnel timeline report 429 includes a timeline displaying a window of 1-3 months from a particular month, such as, “April 2004”, and tasks due by person. When a user selects a previous arrow 437, server 12 generates a report for a month before a current month. Server 12 receives a user's selection of a next arrow 438 and generates a report for a month after a current month. When a user selects a go button 436 on personnel time report 429, server 12 redraws personnel time report 429 with updated settings.

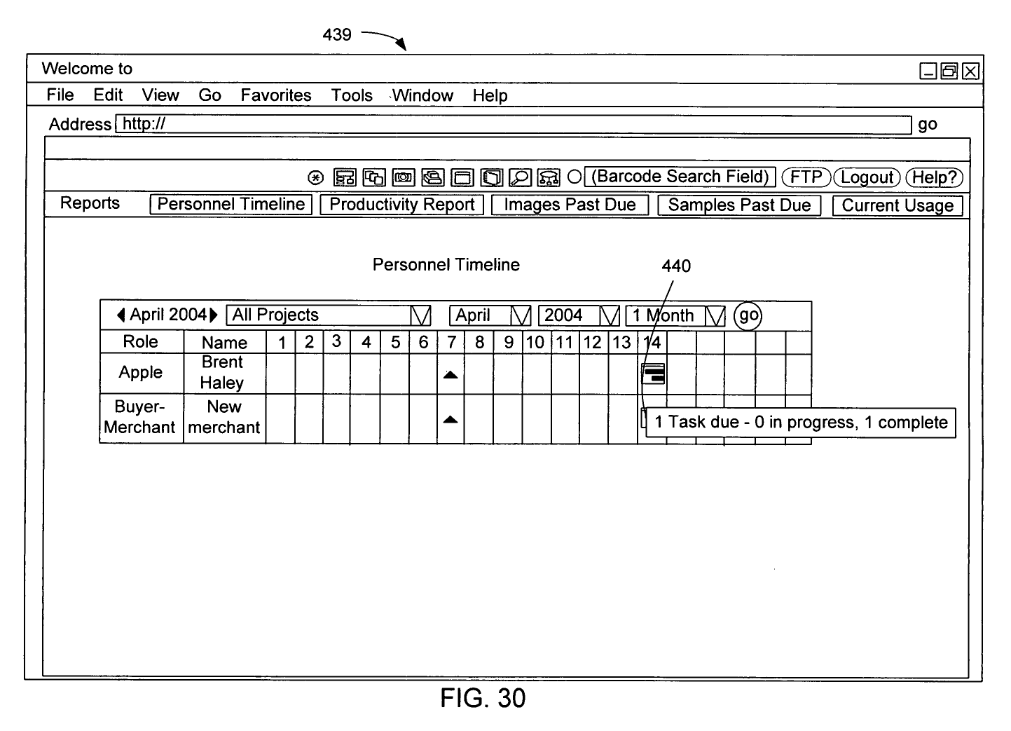

FIG. 30 shows another exemplary personnel timeline report 439. When a user moves a cursor over a due button 440, server 12 displays information showing a total number of tasks due, a number of tasks in progress, and a number of tasks completed. Server 12 receives a vacation schedule for a time period and displays the vacation schedule in a personnel timeline report. When a user selects due button 440, server 12 edits the vacation schedule.

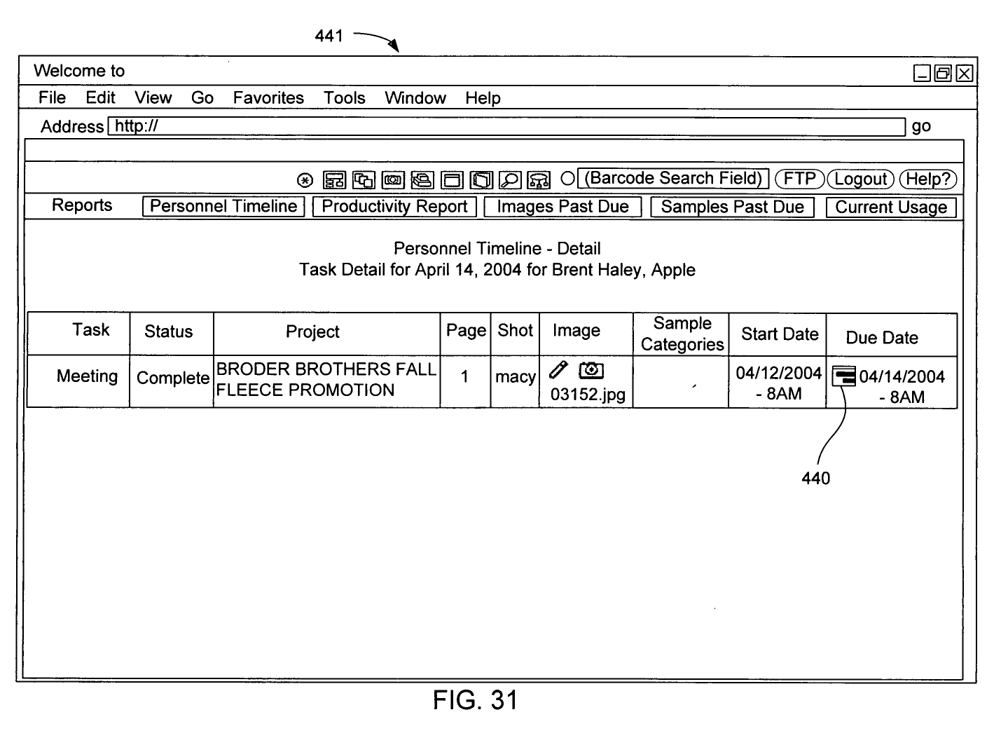

FIG. 31 shows an exemplary timeline detail report 441. When a user selects due button 440 (FIG. 30), timeline detail report 441 showing specific information for a user's workload is generated by server 12. Timeline detail report 441 includes information for all tasks that are due, in progress, or completed by a due date. Server 12 displays due button 440 to the left of a due date for tasks that are due. Server 12 displays completed tasks in a shaded row in timeline detail report 441 so a user can easily determine the completed tasks. Server 12 displays tasks that are due after a due date in timeline detail report 441 when server 12 determines that a start date of the tasks falls before or on the due date. Examples of other kinds of reports displayed by server 12 include productivity reports, a current usage report, and level items past due reports, such as, third level items past due reports and fourth level items past due reports.

A productivity report includes a standard report and a level item detail report, such as a third level item detail report. A standard report includes a number of third level items scheduled to be completed and third level items completed. A level item detail report displays details of each completed level item including a total time spent completing the level item.

A productivity report includes level items, such as third level items, that are completed for selected contacts and for one, more, or all first level items specified. A user selects one or more first level items from a scrolling list, specifies a time period using drop down selection controls, selects a task, selects contacts before running a productivity report, and selects a run report button. When a user selects a run report button, server 12 generates a productivity report.

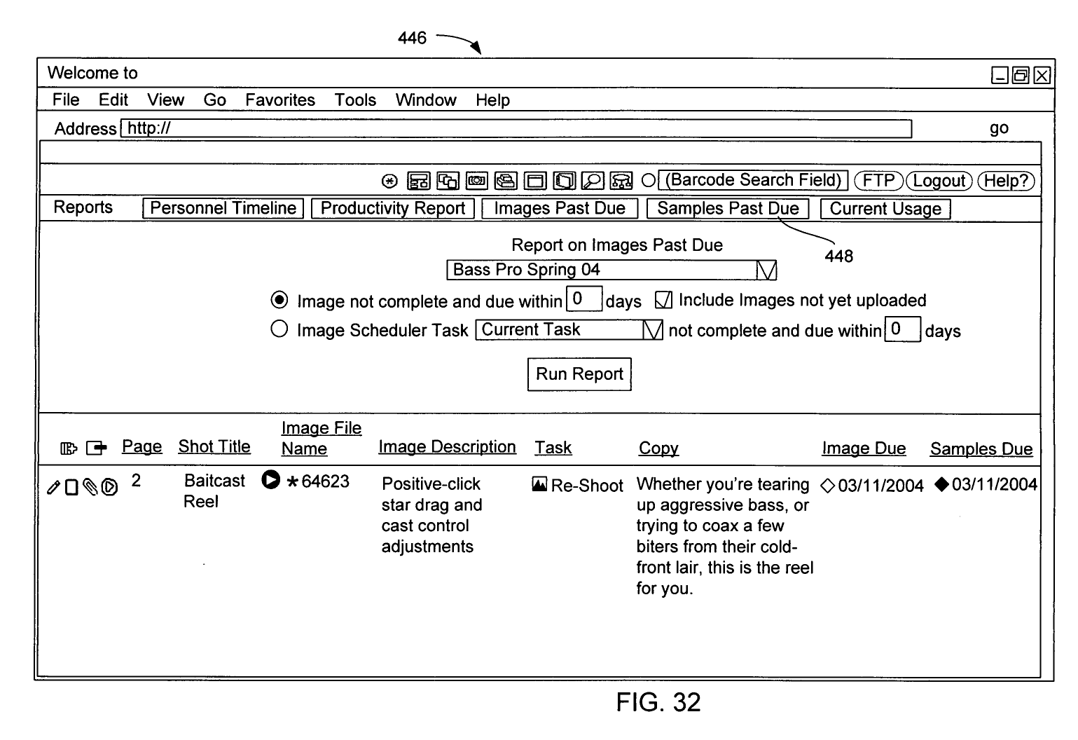

FIG. 32 shows an exemplary third level items past due report 446 generated by server 12 when a user selects third level items past due button 434 (FIG. 29). Third level items past due report 446 includes a fourth level items past due button 448 and includes a listing of third level items that are past due for a specified first level item or for all first level items. Third level items past due report 446 can be narrowed to focus on a specific task in a third level item creation workflow or can include all tasks. When a user selects all options available on third level items past due report 446 and selects a run report button, server 12 generates third level items past due report 446 based on the selected options.

Third level items past due report 446 includes third level item listings in a layout which is similar to regular list view 288 (FIG. 14) of third level item listings. Third level items past due report 446 also includes controls for editing notes, attachments, and other items in a popup menu.

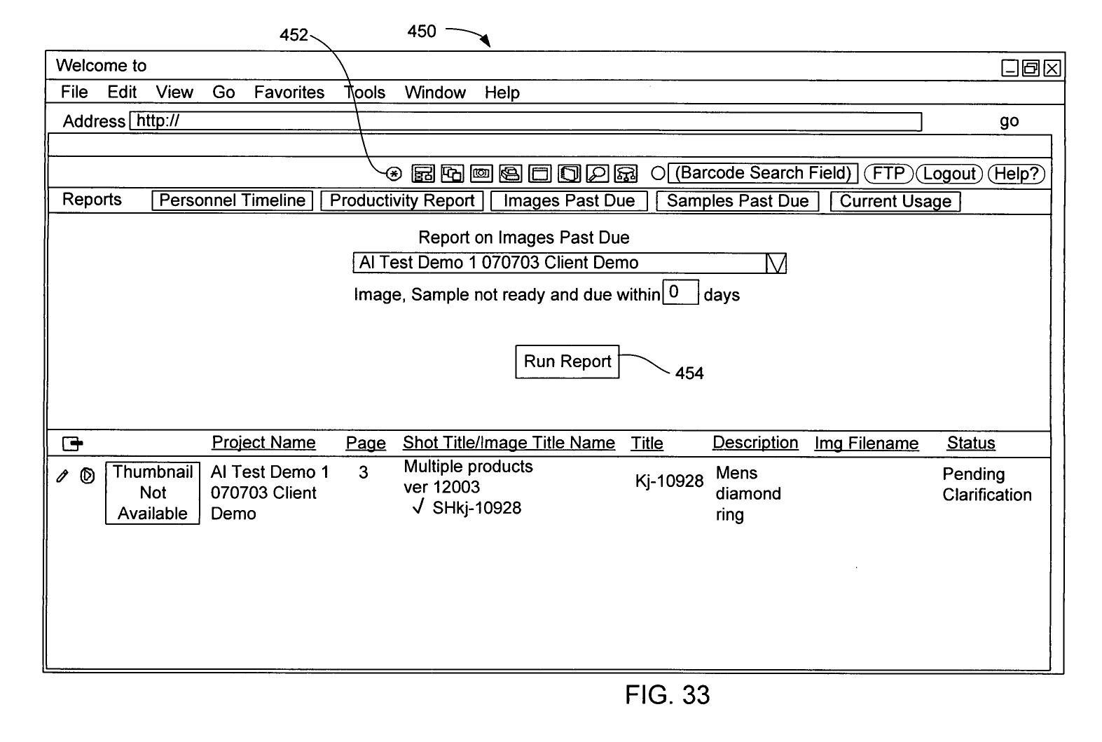

FIG. 33 shows an exemplary fourth level item past due report 450 generated by server 12 when a user selects fourth level items past due button 448 (FIG. 32) on third level items past due report 446 (FIG. 32). Fourth level item past due report 450 includes a shortcut button 452, described below, and a run report button 454. Fourth level items past due report 450 includes a listing of fourth level items which are past due for a specified level item, such as a first level item, or for all level items, such as all first level items. Before server 12 re-generates fourth level item past due report 450, a user selects a level item or all level items. A user also enters a number of days in which fourth level items are due and not completed. When a user selects run report button 454, server 12 re-generates fourth level item past due report 450.

Fourth level item past due report 450 includes fourth level item listings in a layout which is similar to fourth level item listings view 348 (FIG. 18). Fourth level item past due report 450 includes controls for editing notes, attachments, and other items in a popup menu.

A current usage report includes users that are currently logged in and utilizing method 60 for managing information at various levels. Server 12 filters reports according to a user's permission level. When a user logs into server 12 and notices differences between a reports list the user sees and another reports list other users that access server 12 see, the differences are due to differences in permission levels. A reports list includes a set of listings of reports.

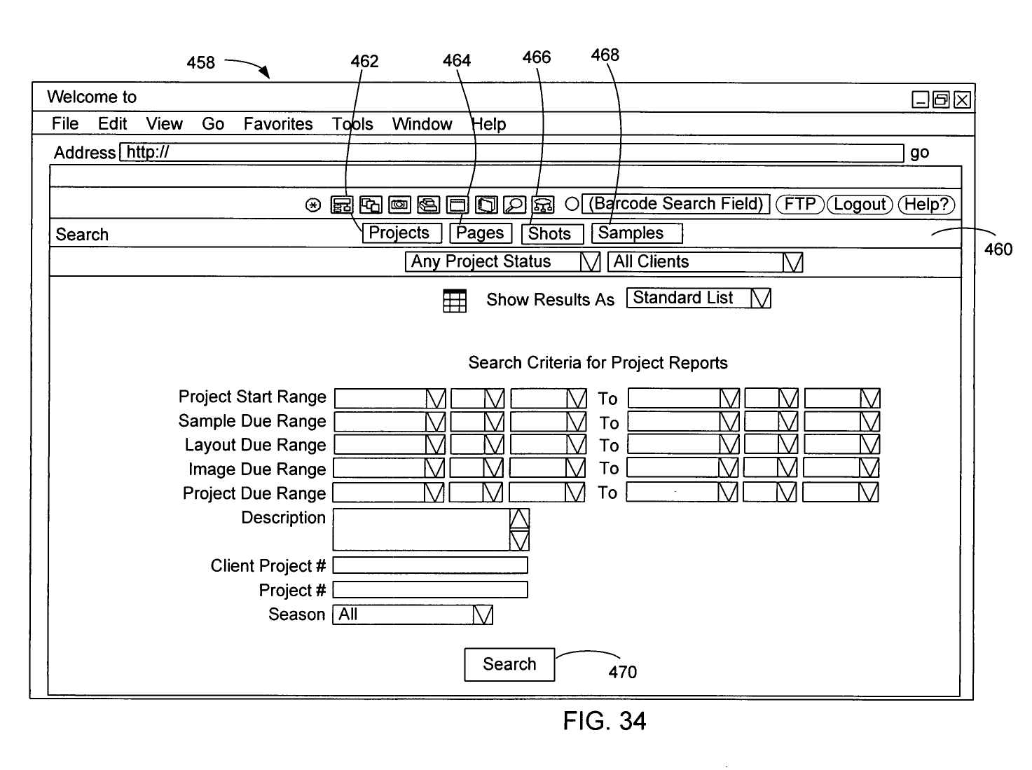

FIG. 34 shows an exemplary search screen 458 generated by server 12 when a user selects search button 112 (FIG. 5). Searches can be performed on first level items, second level items, third level items, and fourth level items. Search screen 458 includes a search bar 460. Search bar 460 includes a first level items button 462, a second level items button 464, a third level items button 466, and a fourth level items button 468.

When a user selects a level items button, server 12 searches for level item listings based on level item attributes specified by the user. For example, when a user selects first level items button 462 and specifies first level item attributes, server 12 searches for first level item listings based on the first level item attributes. Server 12 receives a user's selection of a level items button, receives attributes, and provides search results based on the attributes. For example, a user selects first level items button 462 and provides first level item attributes to generate search results. Examples of first level item attributes include a project status, a client name, a project start range, a sample due range, a layout due range, an image due range, and a project due range. Examples of second level item attributes include a sample due range, a layout due range, and an image due range. Examples of third level item attributes include an image due range and a sample due range. An example of fourth level item attributes includes a status date for a range of days, which shows a status of a fourth level item during the range from the status date.

Server 12 generates a search result by searching for second level items. Server 12 associates each second level item in a search result with a first level item icon. When a user selects a first level item icon, server 12 displays a first level item corresponding to a second level item. When a user selects a first level item icon, server 12 generates a separate pop-up window including a first level item listing corresponding to a second level item in a search result.

Server 12 generates a search result by searching for third level items. Server 12 associates each third level item in a search result with first level item and second level item buttons. When a user selects a first level item button, server 12 displays a first level item corresponding to a third level item. When a user selects a second level item button, server 12 displays a second level item corresponding to a third level item. Server 12 receives a user's selection of a second level item button and generates a pop-up window including a second level item corresponding to a third level item generated from a search. When server 12 determines that a third level item corresponds to a first level item and does not correspond to any second level items, server 12 does not display a second level item button.

Server 12 generates a search result by searching for fourth level items. Server 12 associates each fourth level item in a search result with first level item, second level item, and third level item buttons. When a user selects a first level item button, server 12 displays a first level item corresponding to a fourth level item. When a user selects a second level item button, server 12 displays a second level item corresponding to a fourth level item. When a user selects a third level item button, server 12 displays a third level item corresponding to a fourth level item. Upon receiving a selection of a third level item button from a user, server 12 generates a pop-up window including a third level item corresponding to a fourth level item generated from a search. When server 12 determines that a third level item is assigned directly to a first level item, server 12 does not display second level item and third level item buttons.

A user can specify a format, such as a standard report format or user defined report format, in which a search result is displayed by server 12. A level item listing, such as a first level item listing, and a contact sheet are standard reports. User defined reports are custom made reports that specify columns that appear in the report. Server 12 displays a user defined report in a hypertext markup (html) or a comma separated values (csv) format.

Server 12 performs a search when a user fills in or selects values for any field important to the search and selects a search button 470. When a user selects search button 470, server 12 generates search results in a list view, such as a regular list view. For example, a search for third level items returns search results in regular list view 288 (FIG. 14) of third level item listings.

Server 12 filters search results according to a user's permission level. When a user logs into server 12 and notices differences between search results the user sees and search results another user that logs into server 12 sees, the differences are due to differences in permission levels of the users.

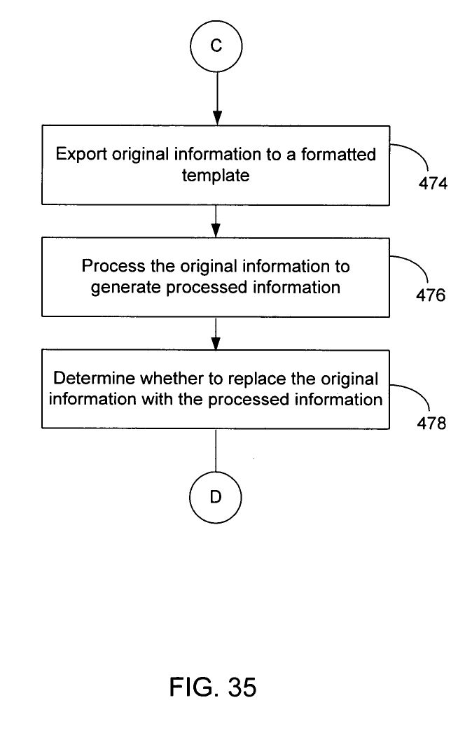

FIG. 35 is a flowchart of an exemplary embodiment of method 60 for managing information at various levels. Method 60 includes exporting 474 original information to a formatted template, processing 476 the original information to generate processed information, and determining 478 whether to replace the original information in the computer with the processed information.

Server 12 can export and import csv and xml (extensible markup language) formatted data. As an example, when a user selects a first level item and an import button, server 12 imports new data objects, which are not within server 12, into the first level item. As another example, when a user selects a second level item and an import button, server 12 imports new data objects into the second level item. An importation of data objects into a level item relies on certain key data fields that are set according to a user's specifications. Each object type, such as a first level item, a second level item, a third level item, and a fourth level item can include a set of keys. Keys can be global or local to a level item. A global key is a value such as an object identification (Id) or a barcode that is unique within server 12. A local key is unique at a level, such as a first level, a second level, a third level, or a fourth level. As described below, server 12 determines whether to update an existing level item or to add a new level item to server 12 based on a value within a key data field.

Examples of keys for a page include a page Id as a global key and a page number as a local key. Examples of keys for an image includes an image Id as a first global key, a barcode as a second global key, and an image name as a local key. Examples of keys for a sample include a sample Id as a global key, a barcode as a global key, and a title as a local key.

When a user selects an export button, selects the original information, and a formatted template, server 12 exports 474 the original information to the formatted template. As an example, server 12 exports selected second level items with associated third level item and fourth level item information. Server 12 creates the formatted template when a user selects an export button. Server 12 exports 474 the original information to the formatted template by populating the formatted template with the original information.

A user controls server 12 to process 476 the original information to generate processed information. As an example, a user controls server 12 to modify data within exported second level items. An another example, a user controls server 12 to clear keys, described below, within exported second level items.

Server 12 determines 478 whether to replace the original information in server 12 with the processed information. Server 12 determines 478 whether to replace the original information in server 12 with the processed information by determining whether a key of the original information matches a key of the processed information. For example, when a user selects an import button, server 12 determines whether a global key of a level item to be imported into server 12 matches a global key of a level item within server 12. As another example, when a user selects an import button, server 12 determines whether a local key of a first level item to be imported into server 12 matches a local key of a level item within application server 12.

Server 12 substitutes the original information with the processed information upon determining that the key of the original information matches the key of the processed information. For example, when server 12 determines that a global key of a level item to be imported into server 12 matches a global key of a level item within server 12, server 12 updates the level item within server 12. As another example, when server 12 determines that a local key of a first level item to be imported into server 12 matches a local key of a level item within server 12, server 12 updates the item within server 12. As yet another example, when server 12 determines that a global key of an exported second level item to be imported into server 12 matches a global key of a second level item within server 12, server 12 imports the exported second level items to update the second level item within server 12.

Server 12 determines 478 whether to replace the original information in server 12 with the processed information by determining whether at least one of the original information and the processed information include a key. Server 12 does not replace the original information with the processed information upon determining that at least one of the original information and the processed information does not include a key. As an example, server 12 ignores empty key values of level items to be imported into server and of level items within server 12.

Server 12 determines 478 whether to replace the original information in the computer with the processed information by determining whether at least one of the original information and the processed information include a key and determining whether the processed information is different than the original information. Server 12 does not replace the original information with the processed information upon determining that at least one of the original information and the processed information does not include a key and upon determining that the processed information is different than the original information.

In one embodiment, server 12 does not replace the original information with the processed information by creating the processed information within server 12. For example, when server 12 determines that key values of level items stored within server 12 and level items to be imported differ in any way, server 12 creates a new level item within server 12. As another example, when server 12 determines that key values of level items stored within server 12 and level items to be imported are empty and determines that a non-key value has changed within the level item to be imported, server 12 creates a new level item within server 12. As yet another example, when a user selects an import button to import a second level item and server 12 does not find a second level item Id of the second level item, server 12 creates a new second level item within server 12. As still another example, when server 12 does not find an Id of an exported second level item and determines that a value of the exported second level item has changed, server 12 imports the exported second level item to make a copy of the exported second level item.

In one embodiment, a key set for a second level item includes a second level item Id and a second level item number. A user controls server 12 to generate a generic import transformation map, such as a ‘.csv’ template, with two second level items including a second level item 1 and a second level item 2, and the second level items correspond to third and fourth level items. A transformation import map is a custom piece of software that provides application server 24 with a manner of organizing data a user wishes to import. A user has a different transformation import map for each type of legacy data the user wishes to import to server 12. A generic import transformation map states that column names of a template within server 12 match exactly column names of a template in which level items are exported. A custom import transformation map states that column names of a template within server 12 match a specification dictated during created of the map. A user also controls server 12 to enter ‘1’ and ‘2’, which are keys corresponding to the second level items 1 and 2. When a user selects an import button, server 12 determines whether the second level item 1 exists within server 12. Server 12 updates the second level item 1 upon determining that the second level item exists within server 12. Server 12 creates the second level item 1 upon determining that the second level item 1 does not exist within server 12. Server 12 follows a similar process for the second level item 2.

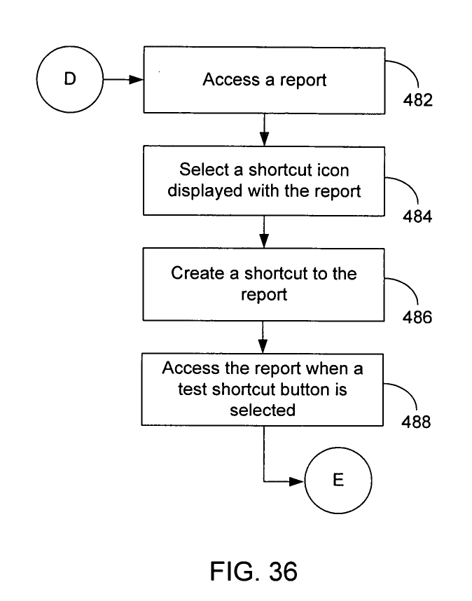

FIG. 36 is a flowchart of an embodiment of method 60 for managing information at various levels. Method 60 includes accessing 482 a report, such as fourth level items past due report 450 (FIG. 33) including information regarding a sample, selecting 484 a shortcut icon, such as shortcut icon 452 (FIG. 33), displayed with the report, creating 486 a shortcut to the report, and accessing 488 the report when a test shortcut button implementing the shortcut is selected.

Server 12 provides a shortcut functionality that allows a user to set shortcuts to pages or menus. Any number of shortcuts can be created. Server 12 memorizes parameters of a plurality of pages when a shortcut is set. For example, when a user accesses, by applying a plurality of filters, a third level item listing corresponding to a first level item and selects a shortcut button, server 12 creates a shortcut to the first level item listing. Server 12 receives a user's selection of a shortcut button and provides access to a first level item listing.

Server 12 provides, via a shortcut functionality, an ability to take complex tasks, such as applying filters at one of first, second, third, or fourth levels to customize a screen. Server 12 provides, via a shortcut functionality, an ability to select a button to access the customized screen. Filters are selections made by a user to access a particular screen. Examples of filters include contacts, a specific first, second, or third level item, a particular task, and a modification of the task, such as canceling a vacation. Examples of complex tasks include searching within disk storage unit 34 for a particular personnel timeline report, such as a personnel time report corresponding a specific first level item or to a specific contact, a specific productivity report, such as a productivity report corresponding to a specific first level item, a specific task, or a specific time period. Additional examples of complex tasks include searching within disk storage unit 34 for a specific third level items past due report, such as a third level items past due report for a specific first level item, a specific task, or a specific number of days of completion. Examples of complex tasks further include searching within disk storage unit 34 for a fourth level item past due report, such as a fourth level item past due report specific to a first level item, or a specific number of days of completion. Other examples of complex tasks include searching for a specific first, second, third, or fourth level item, or a specific task, or any other specific data by applying a combination of attributes.

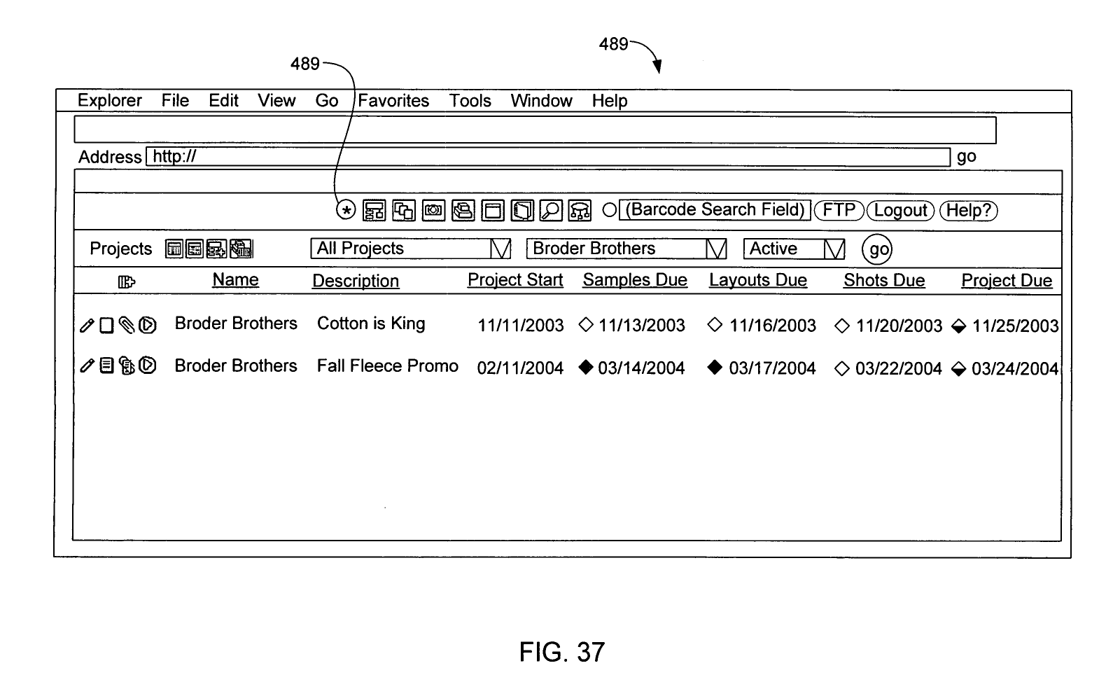

FIG. 37 shows an exemplary regular list view 489 of first level item listings generated by server 12 when a user selects desired filters. A user selects a shortcuts icon 490 on regular list view 489.

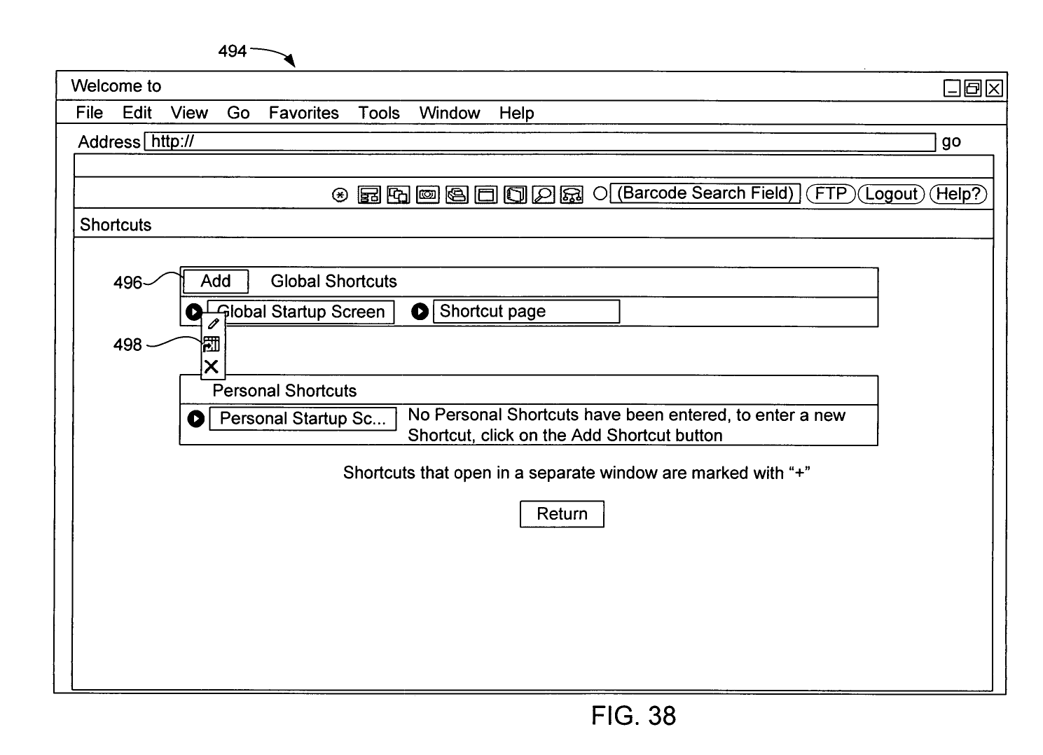

FIG. 38 shows an exemplary shortcuts view 494 generated by server 12 when a user selects shortcut icon 490 (FIG. 37). Shortcuts view 494 includes an add shortcut button 496 and a set button 498. When a user selects once on add shortcut button 496, server 12 generates a shortcut to regular list view 489 (FIG. 37). By selecting add shortcut button 496 once, a user is able to save filters, such as a client name “brother brothers” (FIG. 37) and status of first level items, that the user applied on regular list view 489 (FIG. 37).

A shortcut functionality includes a global shortcut and a personal shortcut. Server 12 provides visibility of a global shortcut to all users accessing a site at which method 60 for managing information at various levels is stored. A user with permission controls server 12 to edit a global shortcut. Server 12 sets a personal shortcut for each user and the user controls server 12 to view or edit the personal shortcut.

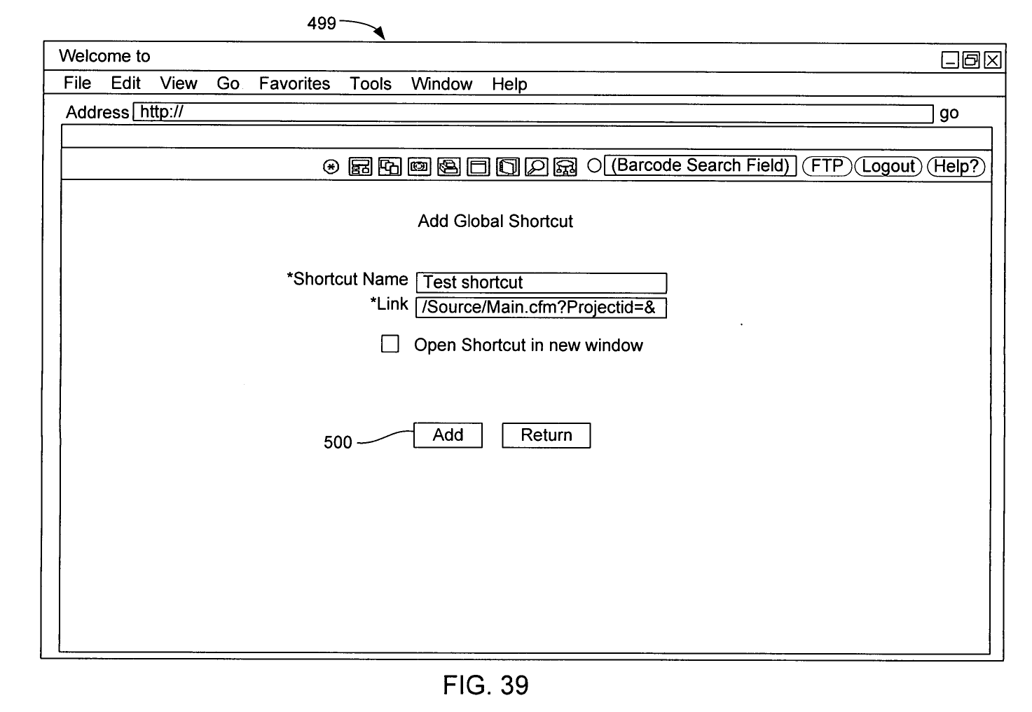

FIG. 39 shows an exemplary add global shortcut screen 499 generated by server 12 when a user selects add shortcut button 496 (FIG. 38). When a user selects add shortcut button 496 (FIG. 38), server 12 prompts the user to provide a short cut name. A user enters a shortcut name and selects an add button 500.

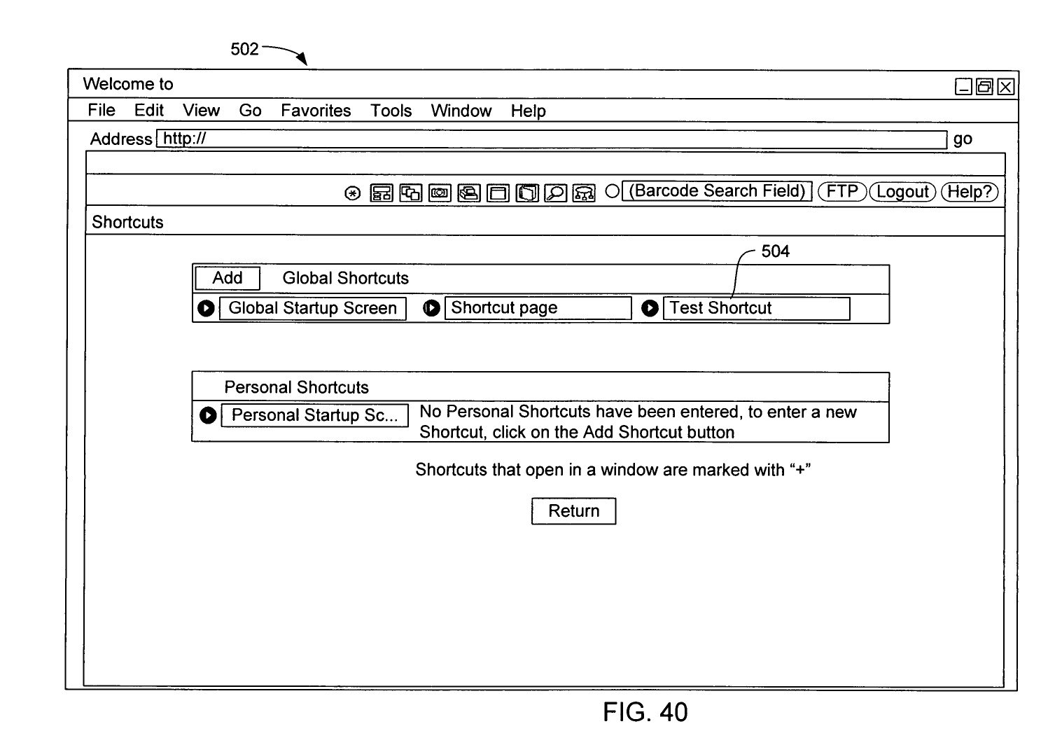

FIG. 40 shows an exemplary shortcuts screen 502 generated by server 12 when a user selects add button 500 (FIG. 39). Shortcuts screen 502 includes a test shortcut button 504. When a user selects test shortcut button 504, server 12 provides access to regular list view 489 (FIG. 37).

Shortcut button 490 (FIG. 37) provides an ability to return to a specific location on the web with a single selection, such as, one click of test shortcut button 504. As an example, the specific location on the web that is accessed by a shortcut displays any of first, second, third, or fourth level items. As another example, the specific location on the web that is accessed by a shortcut displays any one of personnel timeline report 429 (FIG. 29), a productivity report, third level items past due report 446 (FIG. 32), and fourth level items past due report 450 (FIG. 33). In the example, a user selects various filters to search for any of personnel timeline report 429 (FIG. 29), a productivity report, third level items past due report 446 (FIG. 32), and fourth level items past due report 450 (FIG. 33). Moreover, in the example, the user creates 486 (FIG. 36) a shortcut to any of personnel timeline report 429 (FIG. 29), the productivity report, third level items past due report 446 (FIG. 32), and fourth level items past due report 450 (FIG. 33). Furthermore, in the example, the user accesses 488 (FIG. 36) any of personnel timeline report 429 (FIG. 29), the productivity report, third level items past due report 446 (FIG. 32), and fourth level items past due report 450 (FIG. 33) by selecting a shortcut button, such as test shortcut button 504. Server 12 runs all reports before creating a shortcut. For example, when a user desires to create a shortcut to a report, the user controls server 12 to run the report and to set a shortcut to the report.

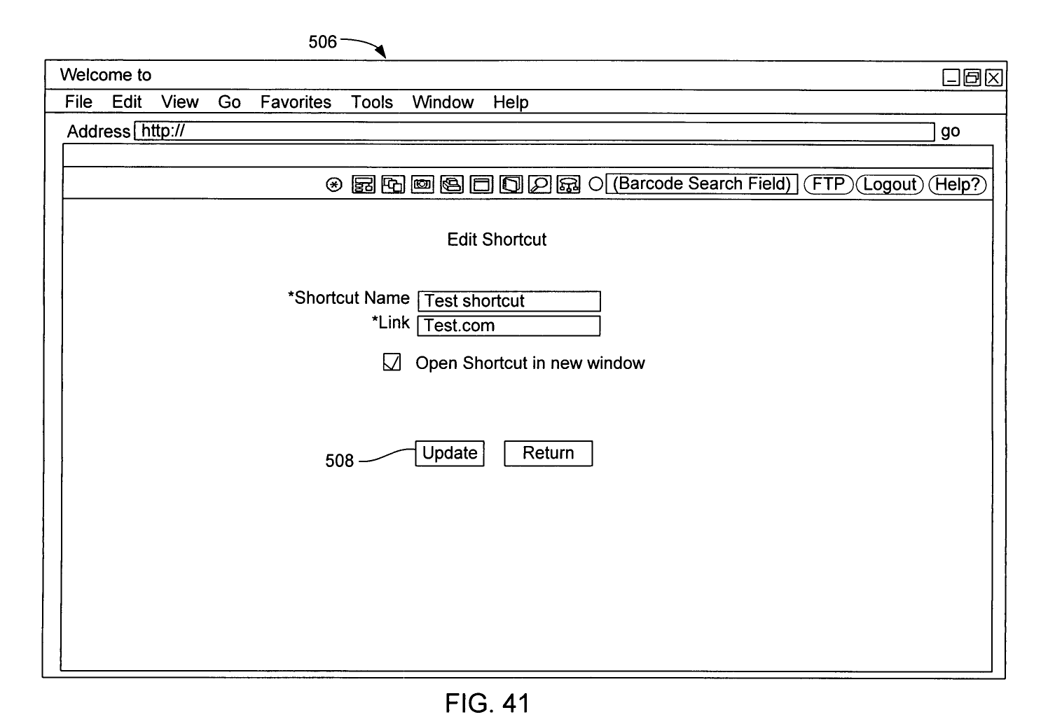

FIG. 41 shows an exemplary edit shortcut view 506 generated by server 12 when a user selects set button 498 (FIG. 38) next to an existing shortcut. A user resets or changes a uniform resource locator (url) for an existing shortcut by changing a url within a link field and selecting an update button 508. Edit shortcut view 506 includes an update button 508.

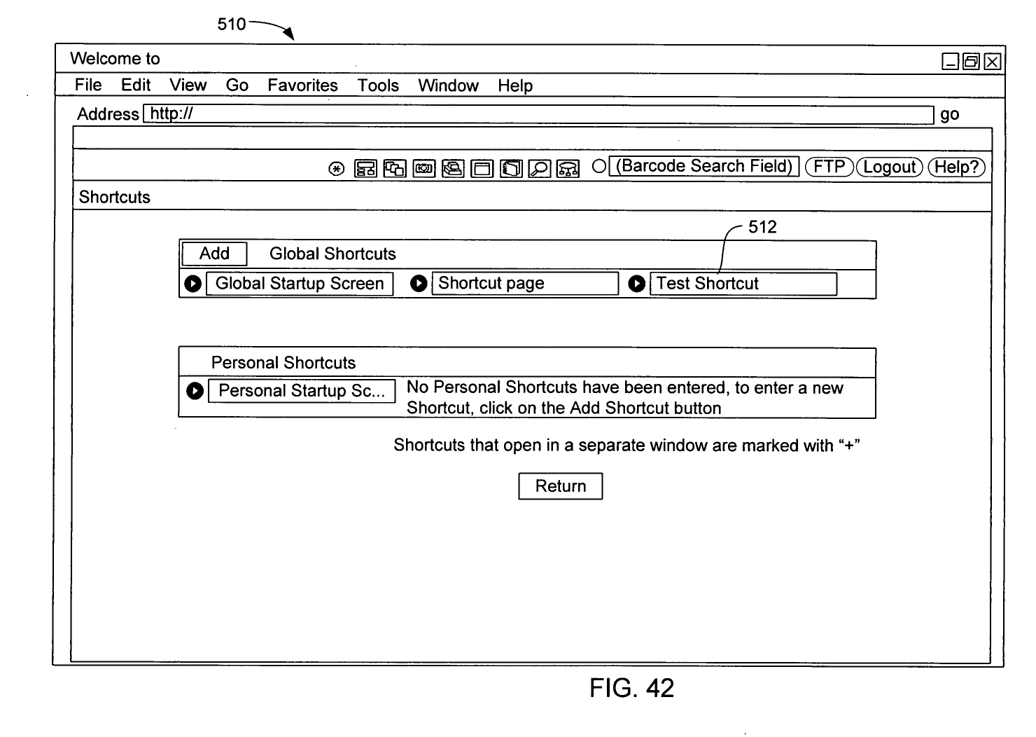

FIG. 42 shows an exemplary shortcuts view 510 generated by server 12 when a user selects update button 508 (FIG. 41). Shortcuts view 510 includes a test shortcut button 512.

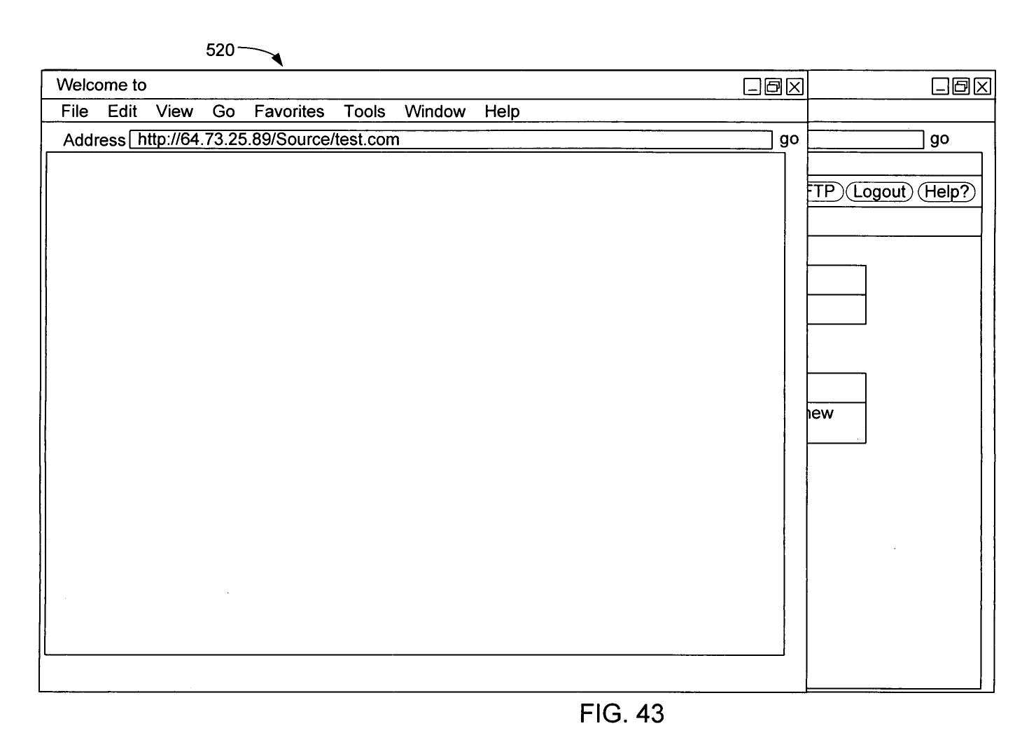

FIG. 43 shows an exemplary web page 520 generated by server 12 when a user selects test shortcut button 512 (FIG. 42). A user can control server 12 to create a shortcut to a url including a url for a site from which method 60 for managing information at various levels can be accessed. Server 12 creates a short cut in the same window from which a shortcut is accessed or alternatively in a different window.

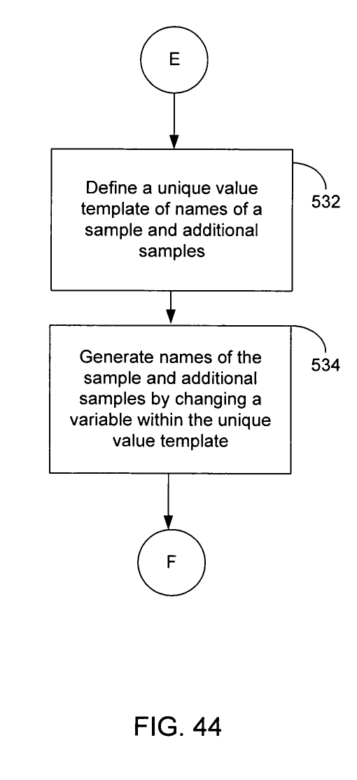

FIG. 44 is a flowchart of an embodiment of method 60 for managing information at various levels. Method 60 includes defining 532 a unique value template of names of a sample and additional samples. A unique value template includes a variable. Method 60 further includes generating 534 names of a sample and additional samples by changing a variable within a unique value template.

When a user controls server 12 to add level items via a bulk entry, server 12 modifies names of the level items according to the unique value template that is setup for a current first level item. Level items are added via a bulk entry when a user controls server 12 to add more than one level item at a time. A user controls server 12 to define 532 a unique value template of a level item. A unique value template communicates with server 12 regarding a manner of generating unique names of level items when the level items are added in bulk. A unique value template includes a number of ‘#’ symbols and optionally includes pre and post characters. Each of ‘#’ symbols is a variable. A number of ‘#’ symbols determines a length of a number that is used when generating unique names of level items.

Server 12 generates 534 names of a sample and additional samples by changing a variable within a unique value template. As an example, when a user adds in bulk three second level items, controls server 12 to set a unique value template for a first level item corresponding to the second level items as ‘#’, to set a name of the second level items as unique, and enters ‘MyPageName’ into a bulk add second level item name field, server 12 generates MyPageName1, MyPageName2, and MyPageName3, which are names of the second level items. As another example, when a user adds three second level items in bulk, controls server 12 to set a name of the second level items as unique, to set a unique value template for a first level item corresponding to the second level items as ‘##’, and enters ‘MyPageName’ into a bulk add second level item name field, server 12 generates MyPageName01, MyPageName02, and MyPageName03, which are names of the second level items. As yet another example, when a user adds three second level items in bulk, enters ‘MyPageName’ into a bulk add second level item name field, controls server 12 to set a name of the second level items as unique, and to set a unique value template for a first level item corresponding to the second level items as ‘_###’, server 12 generates names MyPageName_{—}001, MyPageName_{—}002, and MyPageName_{—}003, which are the names of the second level items. As still another example, when a user adds in bulk three second level items, enters ‘MyPageName’ into a bulk add second level item name field, controls server 12 to set a name of the second level items as unique, and to set a unique value template for a first level item corresponding to the second level items as ‘_A###B’, server 12 generates MyPageName_A001B, MyPageName_A002B, and MyPageName_A003B, which are the names of the second level items.

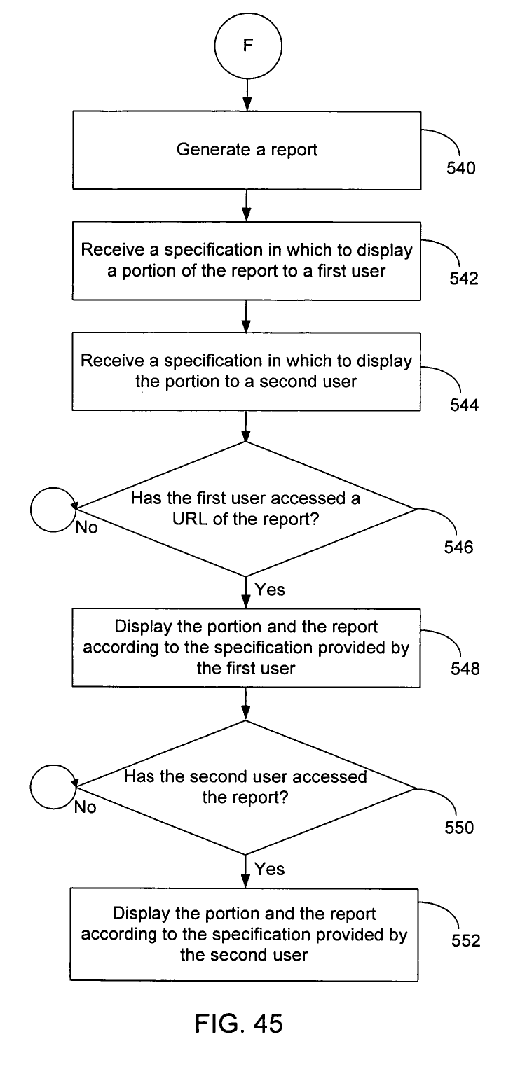

FIG. 45 is a flowchart of an embodiment of method 60 for managing information at various levels. Method 60 includes generating 540 a report, such as fourth level items past due report 450 (FIG. 33), receiving 542 a specification of displaying a portion of the report to a first user, receiving 544 a specification of displaying the portion of the report to a second user, determining 546 whether the first user has accessed a url of the report, displaying 548 the report and the portion according to the specification provided by the first user when the first user accesses a url of the report, determining 550 whether the second user has accessed a url of the report, and displaying 552 the report and the portion according to the specification provided by the second user when the second user accesses the url of the report.

In one embodiment, method 60 for managing information at various levels includes an automatic wizard, which is a computer software accessed from server 12. The automatic wizard obtains data from a user, receives a first selection from the first user regarding a first presentation of the data, receives a second selection from the second user regarding a second presentation of the data, presents the data to the first user so that the first user sees the first presentation of the data, and presents the data to the second user so that the second user sees the second presentation of the data. It is noted that the data that is to be presented can be manipulated based on any number of selections obtained from any number of users. In one embodiment, the automatic wizard provides a template including queries to a user and the user provides selections of a specification of displaying a report by answering the queries.

Server 12 receives 542 a specification of displaying a portion of the report to the first user and receives 544 a specification of displaying the portion of the report to the second user. As an example, an organization has multiple departments, such as a manufacturing department, a design department, and a marketing department. Server 12 receives a first specification from a user in the manufacturing department. The first specification controls server 12 to display ‘footware’ instead of ‘shoes’ when the word ‘shoes’ is displayed to a user of the manufacturing department. A user in the design department provides a second specification to server 12. The second specification states to display ‘apparel’ instead of ‘shoes’ when the word ‘shoes’ is displayed to a user of the design department. A user in the marketing department provides a third specification to server 12. The third specification states to display ‘shoes’ when a word ‘shoes’ is displayed to a user of the marketing department.

Server 12 displays 548 a report and a portion of the report according to a specification provided by the first user when the first user accesses a url of the report. Server 12 displays 552 a report and a portion of the report according to a specification provided by the second user when the second user accesses a url of the report. For example, when server 12 displays any level item information or a report to a user of the manufacturing department with data corresponding to a word ‘shoes’, server 12 displays a word ‘footware’. Similarly, server 12 displays a word ‘apparel’ to a user of the design department, and displays a word ‘shoes’ to a user of the marketing department. Other examples of departments include a multimedia department, an image scanning department, an archiving department, a Senate, a House of Representatives, which are included within an organization. An example of an organization is the Library of Congress. In one embodiment, server 12 has knowledge of whether a user belongs to the design, marketing, or manufacturing department based on the user's password or login Id.

It is noted that customized displays based on specifications provided by a user are not limited to a specific word but also includes images, reports, and other data. It is also noted that the customized displays are not limited to various departments within a specific organization but also includes customized displays for separate organizations. For example, one organization specifies to server 12 that when an image of a cap is shown to a user of the organization, the image be displayed as an isometric view. As another example, another organization specifies to server 12 that when an image of a cap is shown to a user of the organization, the image be a front elevation view. Examples of enterprise standards includes a particular type of image file, such as, jpeg or pdf, and whether a two digit or a four digit number represents a year of due date. Specifications can be based on administrative rules or policies within an organization or departments within the organization.

In one embodiment, uncustomized data is integrated with customized data. For example, when a user customizes a word ‘shoes’ in a shoe report, the automatic wizard customizes the word ‘shoes’ when desired by a user but does not customize other portions of the report when a user accesses the report.

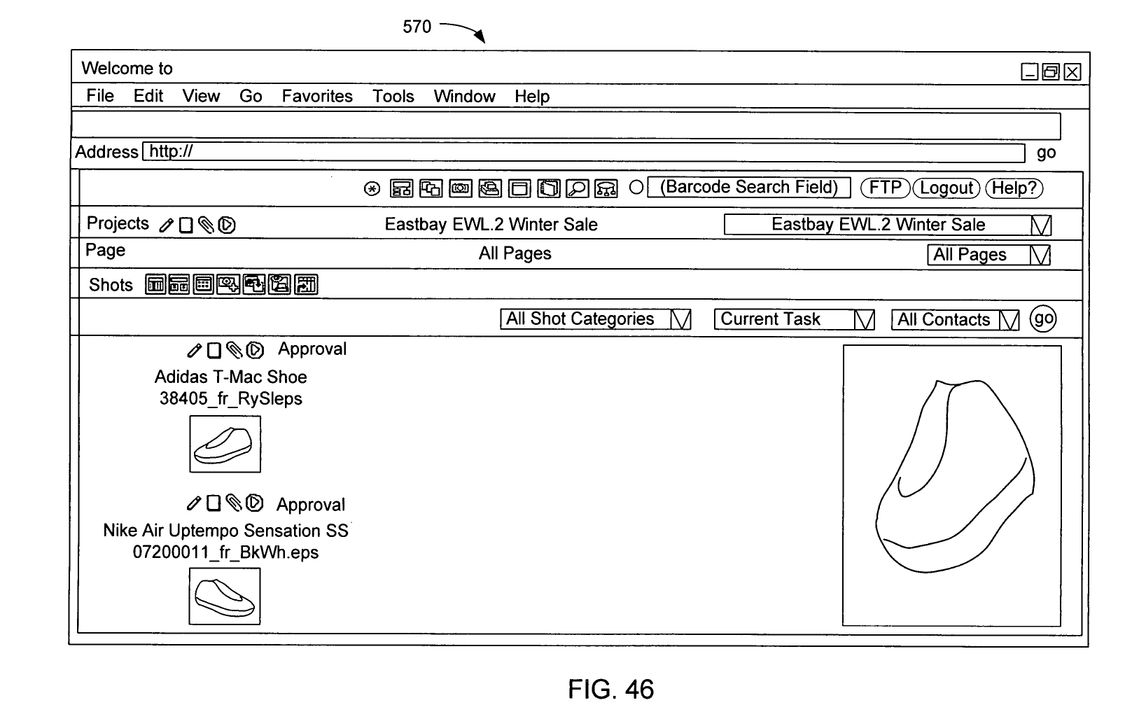

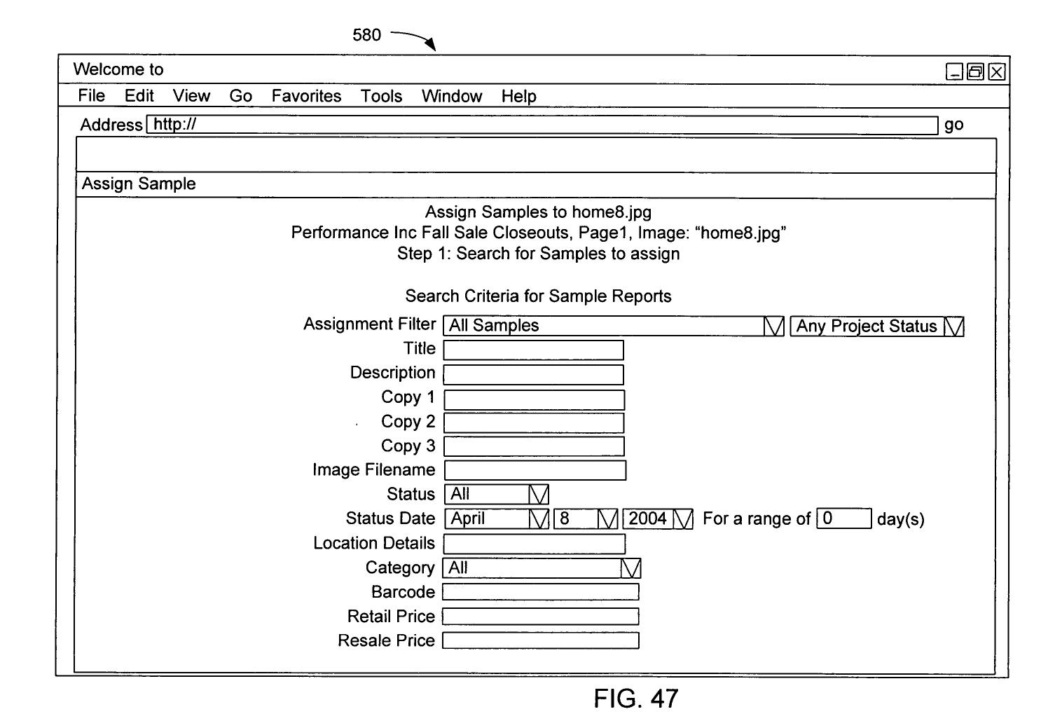

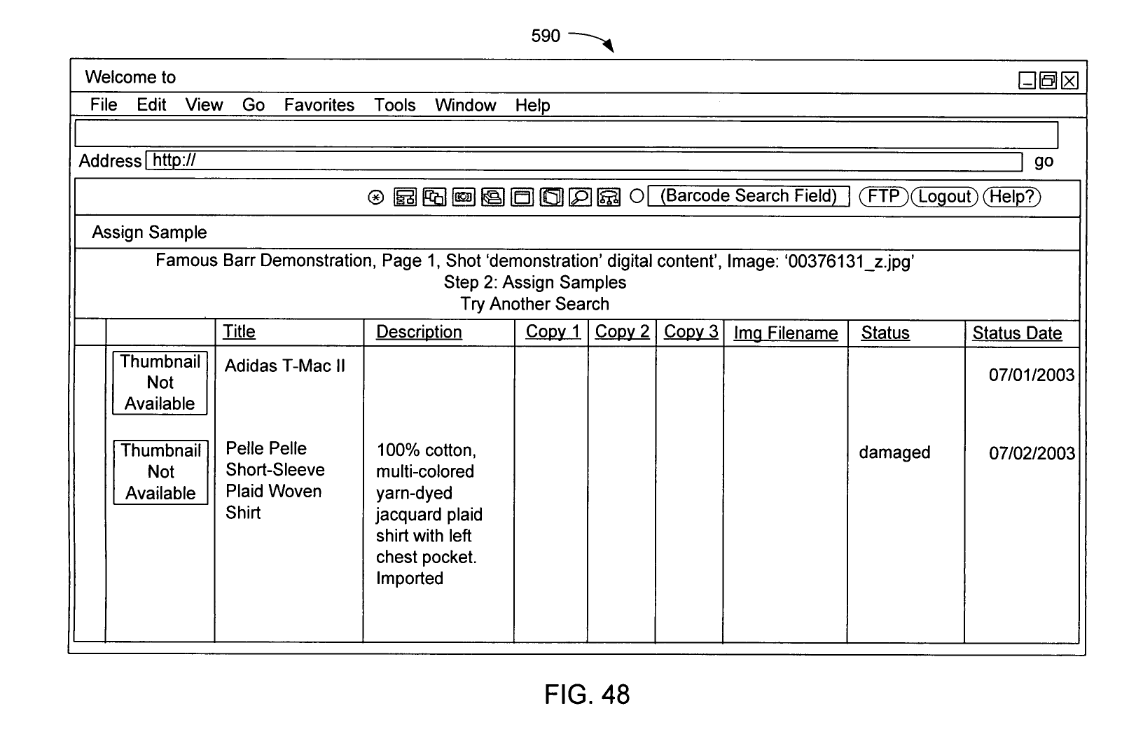

Hence, the various embodiments described above are linked, or associated together at various levels, such as first, second, third, and fourth levels. For example, a user can view images at a project level as shown in a third level item screen 570, shown in FIG. 46, where a project is “Eastbay EWL2 Winter Sale”. Third level item screen 570 is generated by server 12 when a user selects contact sheet button 296 (FIG. 14). As another example, a user can view images at a page level. As yet another example, when a user selects assign fourth level items to this third level item button 332 (FIG. 14), server 12 generates an assign third fourth level items screen 580, shown in FIG. 47. Attributes for searching for samples to assign to an image, such as ‘home8.jpg’, are selected by a user. When a user selects an assign button on assign third fourth level items screen 580, server 12 produces an assign fourth level items screen 590, shown in FIG. 48. A user can select samples to assign on assign fourth level items screen 590 and server 12 assigns the selected samples to an image ‘home8.jpg’. As another example, server 12 associates or links items at various levels with each other when a user selects add second level item editor button 206 (FIG. 9), add third level item editor button 298 (FIG. 14), or add fourth level item editor button 356 (FIG. 18).

It is noted that server 12 may execute 62, 64, 66, 68, 70, 72, 74 of FIG. 3, 390, 392, and 394 of FIG. 22, 474, 476, and 478 of FIG. 35, 482, 484, 486, and 488 of FIG. 36, 532 and 534 of FIG. 44, 540, 542, 544, 546, 548, 550, and 552 of FIG. 45 in an alternative order than the one shown in FIGS. 3, 22, 35, 36, 44, and 45. For example, 474, 476, and 478 of FIG. 35 can be executed after 482, 484, 486, and 488 of FIG. 36. As another example, 390, 392, and 394 of FIG. 22 may be executed after 474, 476, and 478 of FIG. 35.

While the invention has been described in terms of various specific embodiments, those skilled in the art will recognize that the invention can be practiced with modification within the spirit and scope of the claims.

1. A method for managing information at various levels, said method comprising:
obtaining information regarding a sample by scanning a barcode of the sample; and
generating, via a computer, at least one of a schedule of a task to be performed and a contact designated to perform the task, said generating based on the information regarding the sample.

2. A method in accordance with claim 1 further comprising:
receiving, by the computer, a due date and the task to be completed by the due date;
determining, by the computer, whether the contact has completed the task by the due date; and
sending an electronic mail notification upon determining that the contact has not completed the task by the due date.

3. A method in accordance with claim 2 further comprising:
receiving a specification of a group of people, wherein said sending the electronic mail notification includes periodically sending the electronic notification to the group of people specified.

4. A method in accordance with claim 1 further comprising:
generating, via the computer, a report;
receiving, via the computer, a first specification of displaying a portion of the report to a first user;
receiving, via the computer, a second specification of displaying the portion of the report to a second user;
displaying the report and the portion according to the first specification when the first user accesses a uniform resource locator (url) of the report; and
displaying the report and the portion according to the second specification when the second user accesses the url of the report.

5. A method in accordance with claim 1 further comprising:
accessing a report including information regarding the sample;
selecting a shortcut icon displayed with the report;
creating a shortcut to the report; and
accessing the report when a test shortcut button implementing the shortcut is selected.

6. A method in accordance with claim 1 further comprising:
defining a template of names of the sample and additional samples, wherein the template includes a variable; and
generating, by the computer, the names of the sample and the additional samples by changing the variable within the template.

7. A method in accordance with claim 1 further comprising:
creating a first set of listings of the sample and additional samples;
generating a second set of listings of shots of the sample and the additional samples;
developing a third set of listings of pages describing the sample and the additional samples; and
producing a fourth set of listings of projects for obtaining information regarding the sample and the additional samples.

8. A method in accordance with claim 7 further comprising accessing one of the first, second, third, and fourth sets of listings from remaining of the first, second, third, and fourth sets of listings.

9. A method in accordance with claim 1 further comprising:
creating a listing of the sample based on attributes of the sample;
attaching a file to the listing;
associating, within a single database, a listing of the sample, a listing of an image of the sample, a listing of a project for obtaining information regarding the sample, the task, and a due date for completing the task; and
presenting, via a single graphical interface, the listing of the sample, the listing of the image of the sample, the listing of the project for obtaining information regarding the sample, the task, and the due date for completing the task.

10. A method for managing information at various levels, said method comprising:
receiving, by a computer, a due date and a task to be completed by the due date;
determining, by the computer, whether a contact has completed the task by the due date; and
sending, by the computer, an electronic mail notification upon determining that the contact has not completed the task by the due date.

11. A method in accordance with claim 10 further comprising:
receiving a specification of a group of people, wherein said sending the electronic mail notification includes periodically sending the electronic notification to the group of people specified.

12. A method in accordance with claim 10 further comprising:
generating a listing of a project for obtaining information regarding the sample;
generating a listing of the sample based on attributes of the sample, wherein said sending the electronic mail notification comprises transmitting the electronic mail notification upon determining that the contact has not obtained information regarding the sample by the due date.

13. A method for managing information at various levels, said method comprising:
exporting, by a computer, original information to a formatted template;
processing the original information to generate processed information; and
determining, by the computer, whether to replace the original information in the computer with the processed information.

14. A method in accordance with claim 13 wherein said determining whether to replace the original information comprises determining whether a key of the original information matches a key of the processed information.

15. A method in accordance with claim 14 further comprising substituting the original information with the processed information upon determining that the key of the original information matches the key of the processed information.

16. A method in accordance with claim 13 wherein said determining whether to replace the original information comprises determining whether at least one of the original information and the processed information includes a key.

17. A method in accordance with claim 16 further comprising foregoing replacement of the original information with the processed information upon determining that at least one of the original information and the processed information does not include the key.

18. A method in accordance with claim 13 wherein said determining whether to replace the original information comprises:
determining whether at least one of the original information and the processed information includes a key; and
determining whether the processed information is different than the original information.

19. A method in accordance with claim 18 further comprising foregoing replacement of the original information with the processed information upon determining that at least one of the original information and the processed information does not include the key and upon determining that the processed information is different than the original information.

20. A method in accordance with claim 19 further comprising:
creating, by the computer, the formatted template, wherein said foregoing replacement comprises creating, within the computer, the processed information.
